(19) United States
(12) Patent Application Publication
(10) Pub. No.: US 2025/0350874 A1
(43) Pub. Date: Nov. 13, 2025

(54) EAR-CLIP EARPHONES

(71) Applicant: SHENZHEN SHOKZ CO., LTD., Shenzhen (CN)

(72) Inventors: Lei ZHONG, Shenzhen (CN); Haochen LIU, Shenzhen (CN); Shiyu YU, Shenzhen (CN); Jiang XU, Shenzhen (CN); Weijie YUAN, Shenzhen (CN); Xiaobang WEN, Shenzhen (CN)

(73) Assignee: SHENZHEN SHOKZ CO., LTD., Shenzhen (CN)

(21) Appl. No.: 19/274,620

(22) Filed: Jul. 20, 2025

Related U.S. Application Data
(63) Continuation of application No. PCT/CN2024/076388, filed on Feb. 6, 2024.

(30) Foreign Application Priority Data
Dec. 11, 2023 (CN) 202311701969.7

(51) Int. Cl. H04R 1/10

(52) U.S. Cl. CPC H04R 1/105; H04R 1/1016

(57) ABSTRACT

The present disclosure relates to an ear-clip earphone (10) comprising: a sound production portion (11), an abutting portion (12), and an ear hook (13). The ear hook (13) is configured to bypass an antihelix (105) and a helix (107) of the user, and connect the sound production portion (11) and the abutting portion (12). The ear hook (13) has a first symmetry plane (S₁). The housing forms a first projection (11′) on the first symmetry plane (S₁), the abutting portion (12) forms a second projection (12′) on the first symmetry plane (S₁), and the ear hook (13) forms a third projection (13′) on the first symmetry plane (S₁). The first projection (11′) and the second projection (12′) have a shortest connecting line (O₁O₂) or a common tangent point between them. The midpoint of the shortest connecting line (O₁O₂) or the common tangent point is taken as the first feature point (O), and a point on the inner contour curve of the third projection (13′) that is farthest from the first feature point (O) is taken as a second feature point (C). By designing a distance between the first feature point (O) and the second feature point (C), the ear hook (13) is able to bypass the ears of a large proportion of the user population, and is applicable to users with different ear sizes, and at the same time, the ear hook (13) is of a suitable size to avoid the problem of unstable clamping.

### CROSS-REFERENCE TO RELATED APPLICATION

The present application is a continuation of International Application No. PCT/CN2024/076388, filed on Feb. 6, 2024, which claims priority to Chinese Patent Application No. 202311701969.7, filed on Dec. 11, 2023, the entire contents of each of which are hereby incorporated by reference.

### TECHNICAL FIELD

The present disclosure relates to the field of acoustic technology, and in particular, relates to an ear-clip earphone.

### BACKGROUND

Earphones have been widely used in people's daily lives, and they can be used in conjunction with cell phones, computers, and other electronic devices to facilitate the provision of sound playback functions for users. The ear-clip earphones are a new type of earphones, which are usually compact in size and can be used by clamping them to the user's helix, and the ear-clip earphones do not block the ear canal, which not only ensures safety in outdoor scenarios, but is also more comfortable to wear than in-ear earphones. Ear-clip earphones are generally clamped to the user's helix, but different users' ear sizes may vary. In order to avoid the ear-clip earphones squeezing the user's helix in the wearing state, make the ear-clip earphones suitable for more people, and improve wearing comfort, it is necessary to design the ear hook shape of the ear-clip earphones.

Therefore, the present disclosure is desirable to provide an ear-clip earphone, a curve of the ear hook of which is designed to avoid squeezing the user's helix in the wearing state, improve wearing comfort, and make it suitable for users with different ear sizes.

### SUMMARY

Embodiments of the present disclosure provide an ear-clip earphone comprising: a sound production portion configured to be positioned in a concha cavity of a user and contact an inner wall of the concha cavity, wherein the sound production portion comprises: a housing having an accommodating cavity; a sound production assembly accommodated within the accommodating cavity; a sound outlet on the housing configured to transmit sound produced by the sound production assembly; an abutting portion configured to abut behind the user's ear; and an ear hook, wherein the ear hook is configured to bypass an antihelix and a helix of the user, and connect the sound production portion and the abutting portion, the ear hook has a first symmetry plane, the housing is projected onto the first symmetry plane to form a first projection, the abutting portion is projected onto the first symmetry plane to form a second projection, the ear hook is projected onto the first symmetry plane to form a third projection, the third projection includes an inner contour curve, wherein a shortest connecting line is defined between the first projection and the second projection, and a midpoint of the shortest connecting line is a first feature point, a point on the inner contour curve that is farthest from the first feature point is a second feature point, and a distance between the first feature point and the second feature point is in a range of 16 mm-20 mm.

Embodiments of the present disclosure also provide an ear-clip earphone comprising: a sound production portion configured to be positioned in a concha cavity of a user and contact an inner wall of the concha cavity, wherein the sound production portion comprises: a housing having an accommodating cavity; a sound production assembly accommodated within the accommodating cavity; a sound outlet on the housing configured to transmit sound produced by the sound production assembly; an abutting portion configured to abut behind the user's ear; and an ear hook, wherein the ear hook is configured to bypass an antihelix and a helix of the user, and connect the sound production portion and the abutting portion, the ear hook has a first symmetry plane, the housing is projected onto the first symmetry plane to form a first projection, the abutting portion is projected onto the first symmetry plane to form a second projection, the ear hook is projected onto the first symmetry plane to form a third projection, the third projection includes an inner contour curve, wherein the first projection and the second projection are in contact, between the first projection and the second projection, the first projection and the second projection have a first common tangent line, the first common tangent line is tangent to both the first projection and the second projection at a first tangent point, which is a first feature point, a point on the inner contour curve that is farthest from the first feature point is a second feature point, and a distance between the first feature point and the second feature point is in a range of 16.5 mm-20.5 mm.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram illustrating an exemplary ear of a user according to some embodiments of the present disclosure;

FIG. 2 is a schematic diagram illustrating an external contour of an exemplary earphone according to some embodiments of the present disclosure;

FIG. 3A and FIG. 3B are schematic diagrams illustrating exemplary earphones clamped on ears with different sizes according to some embodiments of the present disclosure;

FIG. 4 is a schematic diagram illustrating a projection of an exemplary earphone in a first symmetry plane according to some embodiments of the present disclosure;

FIG. 5 is a schematic diagram illustrating another view of an exemplary ear hook according to some embodiments of the present disclosure;

FIG. 6 is a schematic diagram illustrating a projection of another exemplary earphone in a first symmetry plane according to some embodiments of the present disclosure;

FIG. 7 is a schematic diagram illustrating an internal structure of an exemplary ear hook according to some embodiments of the present disclosure;

FIG. 8A is a schematic diagram illustrating an exemplary earphone in a first steady-state position according to some embodiments of the present disclosure;

FIG. 8B is a schematic diagram illustrating an exemplary earphone in a second steady-state position according to some embodiments of the present disclosure; and

FIG. 9 is a schematic diagram illustrating an exemplary bistable structure according to some embodiments of the present disclosure.

### DETAILED DESCRIPTION

In order to more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that “system,” “device,” “unit,” and/or “module” as used herein are terms used to distinguish different components, elements, parts, sections, or assemblies at different levels. However, if other words serve the same purpose, the words may be replaced by other expressions.

As shown in the present disclosure and claims, the words “one,” “a,” “an,” and/or “the” are not especially singular but may include the plural unless the context expressly suggests otherwise. In general, the terms “comprise,” “comprises,” “comprising,” “include,” “includes,” and/or “including” merely prompt to include operations and elements that have been clearly identified, and these operations and elements do not constitute an exclusive listing. The methods or devices may also include other operations or elements.

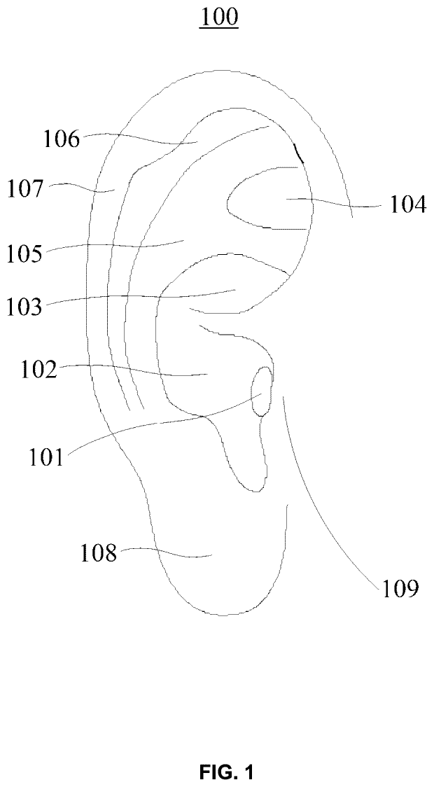

FIG. 1 is a schematic diagram illustrating an exemplary ear of a user according to some embodiments of the present disclosure.

As shown in FIG. 1, an ear 100 may include an ear canal opening 101, a concha cavity 102, a cymba conchae 103, a triangular fossa 104, an antihelix 105, a scapha 106, a helix 107, an earlobe 108, and a tragus 109. In some embodiments, the auricle (also referred to as the pinna) is a general term for other external ear portions of the ear 100 excluding the ear canal opening 101. For example, as shown in FIG. 1, the auricle may include the concha cavity 102, the cymba conchae 103, the triangular fossa 104, the antihelix 105, the scapha 106, the helix 107, the earlobe 108, and the tragus 109. In some embodiments, one or more parts of the ear 100 may be utilized for the wearing and stabilization of an acoustic device (e.g., an earphone). In some embodiments, the ear canal opening 101, the concha cavity 102, the cymba conchae 103, the triangular fossa 104, and other such regions may have a certain depth and volume in a three-dimensional space, and may also be used to meet the wearing requirements of the acoustic device. For example, the acoustic device (e.g., an in-ear earphone) may be worn within the ear canal opening 101. In some embodiments, other parts of the ear 100 (i.e., the auricle) besides the ear canal opening 101 may be utilized for the wearing and stabilization of the acoustic device. For example, the wearing of the acoustic device may be realized with the help of the parts of the cymba conchae 103, the triangular fossa 104, the antihelix 105, the scapha 106, the helix 107, or any combination thereof. In some embodiments, in order to improve the comfort and reliability of the acoustic device in terms of wearing, the earlobe 108 of the user and other parts of the ear 100 may also be further resorted. By utilizing other parts of the ear 100 (i.e., the auricle) apart from the ear canal opening 101, both the wearing and sound transmission of the acoustic device can be achieved, thereby “freeing up” the ear canal opening 101 of the user and reducing the impact of the acoustic device on the ear health of the user. When the user wears the acoustic device while on a roadway, the acoustic device does not block the ear canal opening 101 of the user, allowing the user to receive both sound from the acoustic device and ambient sounds (e.g., horn sounds, bicycle bells, surrounding voices, traffic instructions, etc.), thereby reducing the likelihood of traffic accidents. For example, the whole or a portion of the structure of the acoustic device may be located on the front side of the tragus 109 while the user is wearing the acoustic device. As another example, while the user is wearing the acoustic device, the whole or a portion of the structure of the acoustic device may be in contact with the upper portion of the ear canal opening 101 (e.g., the location of one or more parts such as the tragus 109, the cymba conchae 103, the triangular fossa 104, the antihelix 105, the scapha 106, the helix 107, etc.). As a further example, while the user is wearing the acoustic device, the whole or portion of the structure of the acoustic device may be located within one or more parts of the ear (e.g., the concha cavity 102, the cymba conchae 103, the triangular fossa 104, etc.).

The description of the above ear 100 is for the purpose of exposition only and is not intended to limit the scope of the present disclosure. For those of ordinary skill in the art, a variety of changes and modifications may be made based on the description of the present disclosure. For example, the structure, shape, size, thickness, and other characteristics of one or more parts of the ear 100 may vary among different users. As another example, a part of the structure of the acoustic device may obscure part or all of the ear canal opening 101. These variations and modifications remain within the scope of protection of the present disclosure.

Different users may have individual differences, resulting in different shapes, sizes, and other dimensional differences of the ear 100. For ease of description and understanding, and unless otherwise specified, the present disclosure may primarily refer to an auricle model having a “standard” shape and size, and will further describe how the acoustic device according to various embodiments is worn on this reference auricle model. For example, a simulator containing a head and its ears 100 (left and right ears), constructed in accordance with standards such as ANSI: S3.36, ANSI: S3.25, and IEC: 60318-7, may be used as a reference for wearing the acoustic device. For example, the GRAS45BCKEMAR may be used as the reference for wearing the acoustic device, thereby illustrating a typical wearing scenario for most users. In the present disclosure, terms such as “user is wearing”, “in a worn state,” and “in the wearing state” may refer to the acoustic device being mounted on the ear 100 of the aforementioned simulator as described herein. Of course, considering individual differences among the users, the structure, shape, size, thickness, and other characteristics of one or more parts of the ear 100 may be adapted to various ear shapes and sizes. These design variations may be reflected in different numerical ranges of feature parameters of one or more components of the acoustic device, thereby accommodating different ears 100. It is further noted that the term “non-wearing state” does not merely refer to the acoustic device not being worn on the ear 100 of the user, but also encompasses a state in which the acoustic device is not deformed by external forces. Similarly, the term “wearing state” does not merely refer to the acoustic device being worn on the ear 100 of the user, it may also refer to a configuration in which the various components (e.g., an abutting portion, an ear hook, and a housing of a sound production portion) of the acoustic device are positioned such that their relative arrangement matches that of the acoustic device when worn (e.g., maintaining corresponding distances between the components), even if the acoustic device is not currently being worn.

It should be noted that in fields such as medicine and anatomy, three fundamental anatomical planes are defined: a sagittal plane, a coronal plane, and a horizontal plane. Correspondingly, three primary anatomical axes are also defined: a sagittal axis, a coronal axis, and a vertical axis. The sagittal plane refers to a section perpendicular to the ground along the front-rear direction of the human body, which divides the human body into left and right parts. The coronal plane refers to a section perpendicular to the ground along the left-right direction of the human body, which divides the human body into front and rear parts. The horizontal plane refers to a section parallel to the ground along the up-down direction of the human body, which divides the human body into upper and lower parts. Correspondingly, the sagittal axis refers to an axis along the front-rear direction of the human body and perpendicular to the coronal plane. The coronal axis refers an axis along the left-right direction of the human body and perpendicular to the sagittal plane. The vertical axis refers to an axis along the up-down direction of the body and perpendicular to the horizontal plane. Further, the “front side of the auricle” as described in the present disclosure is a concept relative to the “rear side of the auricle” or the “back side of the auricle,” where the former refers to a side of the auricle away from the head, and the latter refers to a side of the auricle facing the head, both of which are directed at the auricle of the user. Observing the auricle of the above simulator along the direction where the coronal axis of the human body is located, a schematic diagram illustrating the front side of the auricle as shown in FIG. 1 is obtained.

The description of the above ear 100 is for the purpose of exposition only and is not intended to limit the scope of the present disclosure. For those of ordinary skill in the art, a wide variety of changes and modifications may be made based on the description of the present disclosure. For example, a part of the structure of the acoustic device may obscure part or all of the ear canal opening 101. These variations and modifications remain within the scope of protection of the present disclosure.

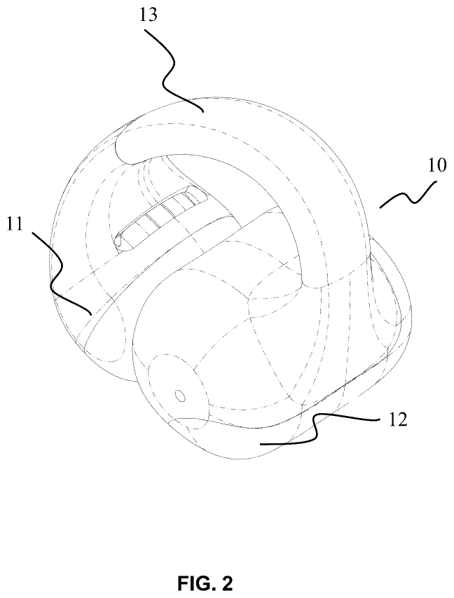

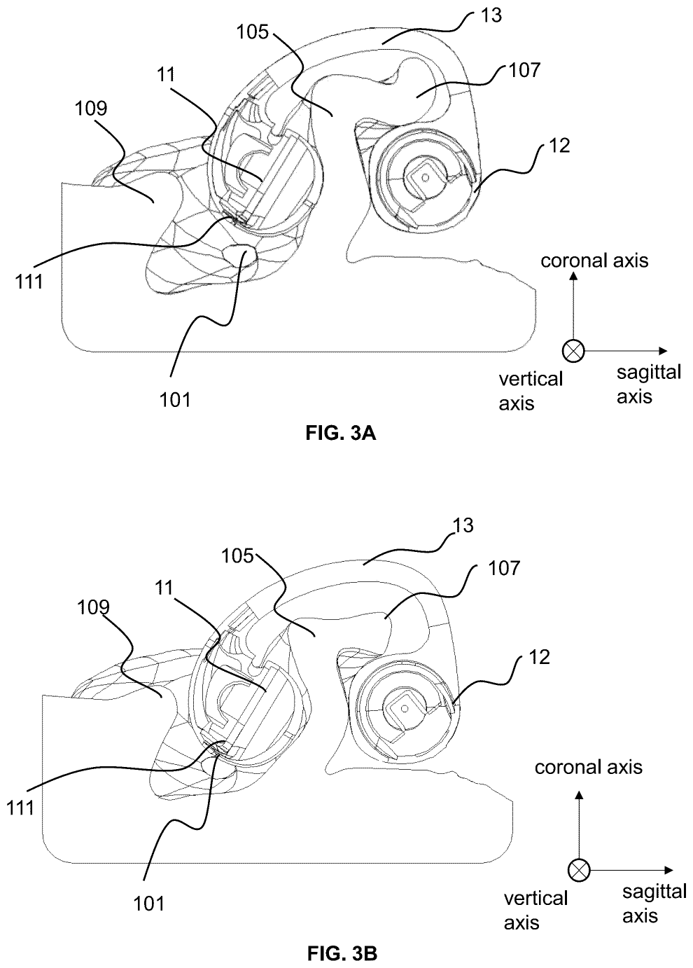

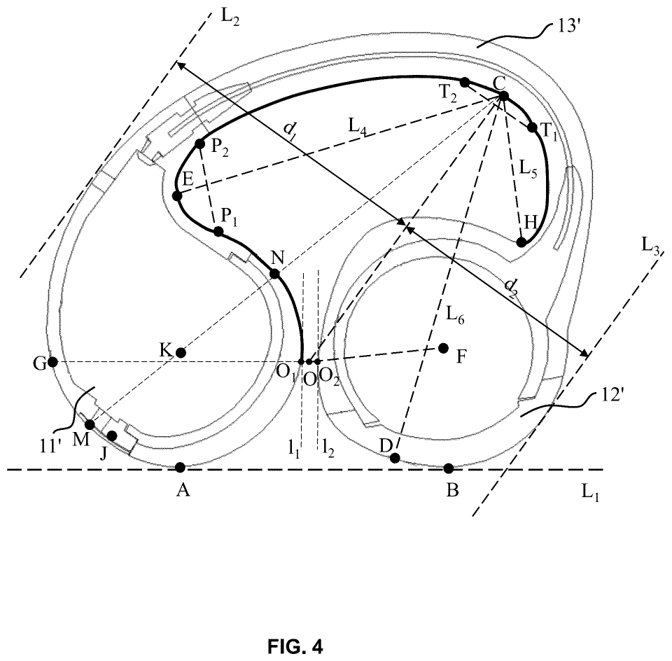

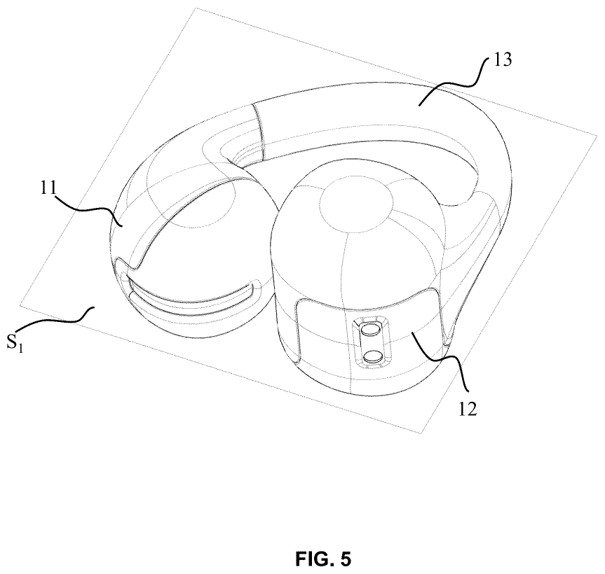

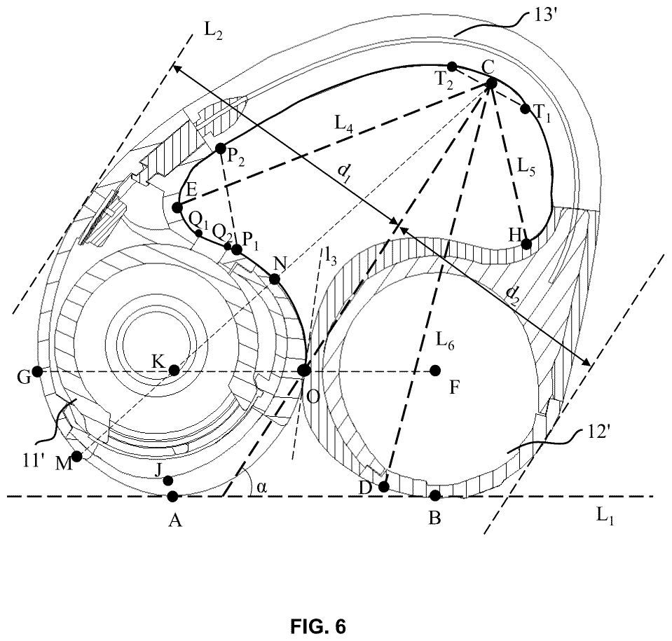

FIG. 2 is a schematic diagram illustrating an external contour of an exemplary earphone according to some embodiments of the present disclosure. FIG. 3A and FIG. 3B are schematic diagrams illustrating exemplary earphones clamped on ears of different sizes according to some embodiments of the present disclosure. FIG. 4 is a schematic diagram illustrating a projection of an exemplary earphone in a first symmetry plane according to some embodiments of the present disclosure. FIG. 5 is a schematic diagram illustrating another view of an exemplary ear hook according to some embodiments of the present disclosure. FIG. 6 is a schematic diagram illustrating a projection of another exemplary earphone in a first symmetry plane according to some embodiments of the present disclosure. The following description, referring to FIG. 1-FIG. 6, explains the configuration and operation of an ear-clip earphone.

Referring to FIG. 2, FIG. 3A, and FIG. 3B, in some embodiments, the ear-clip earphone 10 mainly includes a sound production portion 11, an abutting portion 12, and an ear hook 13. The sound production portion 11 is configured to be positioned in a concha cavity 102 of a user and contact an inner wall of the concha cavity 102, the abutting portion 12 is configured to abut behind the user's ear, and the ear hook 13 is configured to connect the sound production portion 11 and the abutting portion 12. Through the contact between the sound production portion 11, the abutting portion 12, and the ear, the earphone 10 is clamped. In some embodiments, the sound production portion 11 refers to a sound playing device, which is used to convert an electrical signal into an acoustic signal and play it back to the user. The abutting portion 12 forms a clamping state with the sound production portion 11 so as to clamp the earphone 10 near the helix of the user. In some embodiments, the abutting portion 12 may be used as a battery compartment for mounting a battery or other components. In other embodiments, the abutting portion 12 may not be used as the battery compartment, and the battery may be installed into the sound production portion 11.

In some embodiments, the sound production portion 11 includes a housing (not shown in the figures) and a sound production assembly (not shown in the figures), with an accommodating cavity (not shown in the figures) provided in the housing, and the sound production assembly accommodated within the accommodating cavity. The sound production assembly is a module capable of converting the electrical signal into the acoustic signal. In some embodiments, the sound production assembly may be a loudspeaker or the like. In some embodiments, the count of loudspeakers in the sound production assembly may be one or two or more. In some embodiments, the housing may be provided with a sound outlet 111, which is configured to export sound generated by the sound production assembly. In some embodiments, the sound outlet 111 may be directed toward the ear canal opening 101 of the user in the wearing state, as shown in FIG. 3A and FIG. 3B, to allow the sound generated by the sound production assembly to be directly transmitted to the ear canal opening 101, thereby enhancing the hearing effect of the ear canal opening 101 of the user.

With reference to FIG. 3A and FIG. 3B, the sizes of the ears of different users may be different. For example, the ear of a user shown in FIG. 3A has a larger helix, and the ear of a user shown in FIG. 3B has a smaller helix. In order to make the earphone 10 applicable to users with different ear sizes, and at the same time to prevent the ear hook 13 from squeezing the helix of the user in the wearing state, the curve of the ear hook 13 may be designed.

In some embodiments, the ear hook 13 may be symmetrically disposed, and the ear hook 13 has a first symmetry plane S1. In some embodiments, in the wearing state as shown in FIG. 3A and FIG. 3B, the first symmetry plane S1 may be parallel to the horizontal plane (i.e., the paper surface shown in FIG. 3A and FIG. 3B). In some embodiments, the first symmetry plane S1 may be located at a midpoint position in the width direction of the ear hook 13. The first symmetry plane S1 may divide, along the length direction of the ear hook 13 (i.e., the direction extending from an end of the ear hook 13 connected to the sound production portion 11 to an end connected to the abutting portion 12), the ear hook 13 into two portions that are symmetric with respect to the first symmetry plane S1.

In some embodiments, the housing of the sound production portion 11 is projected onto the first symmetry plane S1 to form a first projection 11′, the abutting portion 12 is projected onto the first symmetry plane S1 to form a second projection 12′, and the ear hook 13 is projected onto the first symmetry plane S1 to form a third projection 13′. In some embodiments, the first projection 11′ has a lowest point A, the second projection 12′ has a lowest point B, and the first projection 11′ and the second projection 12′ have a common tangent line L₁ passing through points A and B, where the tangent line L₁ is tangent to the first projection 11′ at point A and to the second projection 12′ at point B.

For ease of understanding, the following description is given by way of example in which the earphone 10 is placed on the horizontal plane and the first symmetry plane S1 is perpendicular to the horizontal plane. The contact point of the sound production portion 11 with the horizontal plane is point A, and the contact point of the abutting portion 12 with the horizontal plane is point B, i.e., the sound production portion 11 is tangent to the horizontal plane at point A and the abutting portion 12 is tangent to the horizontal plane at point B. At this time, the straight line L₁ where points A and B are located in FIG. 4 and FIG. 6 may be regarded as a projection of the horizontal plane on the first symmetry plane S1, and the straight line L₁ is simultaneously tangent to the first projection 11′ at point A and to the second projection 12′ at point B. The first symmetry plane S1 is parallel to the plane in which the paper surface shown in FIG. 4 and FIG. 6 is located.

In some embodiments, the third projection 13′ includes an inner contour curve and an outer contour curve. The inner contour curve corresponds to one side of the contour of the ear hook 13 near the helix in the wearing state, and the outer contour curve corresponds to the other side of the contour of the ear hook 13 away from the helix in the wearing state. On the first projection 11′, with point A as a demarcation point, the portion connected to the inner contour curve of the third projection 13′ is the inner contour of the first projection 11′; the portion connected to the outer contour curve of the third projection 13′ is the outer contour of the first projection 11′. On the second projection 12′, with point B as a demarcation point, the portion connected to the inner contour curve of the third projection 13′ is the inner contour of the second projection 12′; the portion connected to the outer contour curve of the third projection 13′ is the outer contour of the second projection 12′. According to some embodiments of the present disclosure, with points A and B serving as boundaries, the inner contour of the earphone 10 is collectively formed by sequentially connecting the inner contour of the first projection 11′, the inner contour of the third projection 13′, and the inner contour of the second projection 12′. Likewise, the outer contour of the earphone 10 is collectively formed by sequentially connecting the outer contour of the first projection 11′, the outer contour of the third projection 13′, and the outer contour of the second projection 12′.

Referring to FIG. 4, in some embodiments, when the sound production portion 11 is not in contact with the abutting portion 12 (as shown in FIG. 4), there is a shortest connecting line between the first projection 11′ and the second projection 12′. The shortest connecting line refers to a connecting line that connects the two closest points between the first projection 11′ and the second projection 12′. In some embodiments, the two endpoints of the shortest connecting line are located on the inner contour of the first projection 11′ and the inner contour of the second projection 12′, respectively. That is, the shortest connecting line between the first projection 11′ and the second projection 12′ is located between the inner contour of the first projection 11′ and the inner contour of the second projection 12′. In some embodiments, a point O₁ is taken on the inner contour of the first projection 11′ to determine a tangent line I₁ passing through the point O₁ on the inner contour of the first projection 11′, and a point O₂ is taken on the inner contour of the second projection 12′ to determine a tangent line I₂ passing through the point O₂ on the inner contour of the second projection 12′. When the tangent line I₁ is parallel to the tangent line I₂, and a line connecting the point O₁ with the point O₂ is perpendicular to the tangent line I₁ and the tangent line I₂, the line connecting the point O₁ with the point O₂ is the shortest connecting line between the inner contour of the first projection 11′ and the inner contour of the second projection 12′, i.e., the shortest connecting line between the first projection 11′ and the second projection 12′.

In some embodiments, the shortest connecting line between the first projection 11′ and the second projection 12′ may also be determined by tools, programs, or the like. For example, by inputting one or more contour curve parameters of the earphone 10 (e.g., an analog curve function of the inner contour of the earphone 10, an analog curve function of the outer contour of the earphone 10, etc.), a corresponding tool, program, etc., may output information (e.g., a position, an endpoint, etc.) of the shortest connecting line between the first projection 11′ and the second projection 12′.

In some embodiments, when the sound production portion 11 in not in contact with the abutting portion 12, the shortest connecting line O₁O₂ has a midpoint O, which is a first feature point, as shown in FIG. 4. The position of the first feature point O may be used to reflect a fitting area of the sound production portion 11 and the abutting portion 12 with the user's ear under the wearing state, so as to reflect the wearing state of the earphone 10, and to facilitate the determination of a position posture of the sound production portion 11 and the abutting portion 12 in the wearing state, thereby facilitating the subsequent design of the ear hook 13.

In other embodiments, when the sound production portion 11 comes into contact with the abutting portion 12, as shown in FIG. 6, there is a fitting area or a fitting point between the first projection 11′ and the second projection 12′, and a center point (e.g., a centroid, a center of the area, etc.) of the fitting area or the fitting point may be used as the first feature point O. In some embodiments, when the sound production portion 11 is in contact with the abutting portion 12, the inner contour of the first projection 11′ fits the inner contour of the second projection 12′. At this time, a common tangent line Is may be determined on the inner contour of the first projection 11′ and the inner contour of the second projection 12′, which is simultaneously tangent to both the inner contour of the first projection 11′ and the inner contour of the second projection 12′ at the first tangent point O. In some embodiments, point O may be the first feature point. In some embodiments, when the contact region between the sound production portion 11 and the abutting portion 12 is a surface, the centroid of the projection of the contact surface on the first symmetry plane S1 is defined as the first feature point O. In some embodiments, when the sound production portion 11 comes into contact with the abutting portion 12, a side of the first projection 11′ away from the third projection 13′ and a side of the second projection 12′ away from the third projection 13′ have a common tangent line (i.e., the common tangent line L₁), a second tangent point of the common tangent line L₁ to the first projection 11′ is point A, and a third tangent point of the common tangent line L₁ to the second projection 12′ is point B. The connecting line between point A and point B (i.e., the connecting line AB, the line L₁) may be defined as a reference connecting line L₁.

In some embodiments, when the sound production portion 11 is not in contact with the abutting portion 12, an endpoint of the shortest connecting line O₁O₂ on the first projection 11′ is defined as point O₁. In the wearing state, a point on the sound production portion 11, which corresponds to the of the point O₁, is covered by the concha cavity, i.e., the corresponding point of the point O₁ on the sound production portion 11 is located near the fitting point where the sound production portion 11 fits to the concha cavity of the user in the wearing state. In other words, the sound production portion 11 cooperates with the abutting portion 12 through the corresponding point of the point O₁ (and its surrounding area), thereby achieving the clamping of the earphone 10.

Correspondingly, when the sound production portion 11 comes in contact with the abutting portion 12, a point on the sound production portion 11, which corresponds to the first feature point O, is covered by the concha cavity in the wearing state, i.e., the corresponding point of the point O on the sound production portion 11 is located near the fitting point where the sound production portion 11 fits to the concha cavity of the user in the wearing state. In other words, the sound production portion 11 cooperates with the abutting portion 12 through the corresponding point of the point O (and its surrounding area), thereby achieving the clamping of the earphone 10.

In some embodiments, the inner contour curve of the third projection 13′ includes at least one point C that is located farthest from the first feature point O. In some embodiments, if there is a plurality of points that are farthest away from the first feature point O, a point among these farthest points that is closest to the second projection 12′ of the abutting portion 12 may be selected as a second feature point C. The second feature point C may be determined by tools, programs, or the like. For example, by inputting the contour curve parameters of the earphone 10 (e.g., an analog curve function of the inner contour of the earphone 10, an analog curve function of the outer contour of the earphone 10, etc.), a corresponding tool, program, etc., may determine information of the first feature point O, thereby outputting information (e.g., a position, etc.) of the second feature point C.

In some embodiments, as shown in conjunction with FIG. 3A, FIG. 3B, FIG. 4, and FIG. 6, in the wearing state, the point O is located in the vicinity of the contact point between the sound production portion 11 and the concha cavity, and the helix is located in a region surrounded by the inner contour of the ear hook 13, and the helix is substantially located in a region farthest from the point O on the inner contour of the ear hook 13. In order to enable the earphone 10 to bypass the ear of the user without squeezing or interfering with the ear, the first feature point O and the second feature point C may be designed such that the ear hook 13 of the earphone 10 may bypass a relatively large proportion of the ear of the user in the wearing state, thereby making the earphone 10 suitable for more people.

If a distance between the first feature point O and the second feature point C is too small, it will lead to the ear hook 13 in the wearing state squeezing and interfering with the helix of a larger count of the user populations, which will affect the comfort of wearing and the effect of the clamping. If the distance between the first feature point O and the second feature point C is too large, it will lead to the overall size of the ear hook 13 being too large, and the earphone 10 will be prone to unstable clamping.

In some embodiments, when the abutting portion 12 is not in contact with the sound production portion 11, in order to enable the ear hook 13 to bypass the ears of a larger proportion of the users, and at the same time to make the ear hook 13 to have a suitable size to avoid the problem of unstable clamping, the distance (i.e., the length of the line segment OC shown in FIG. 4) between the first feature point O and the second feature point C may be in a range of 16 mm-20 mm. In some embodiments, in order to further adapt the ear hook 13 to more ear sizes, the distance between the first feature point O and the second feature point C may be in a range of 16.5 mm-19 mm. In some embodiments, in order to avoid the size of the ear hook 13 being too large and to avoid the problem of unstable clamping, the distance between the first feature point O and the second feature point C may be in a range of 16.7 mm-18 mm. Merely by way of example, the distance between the first feature point O and the second feature point C may be 17.0 mm.

In some embodiments, when the abutting portion 12 comes into contact with the sound production portion 11, the distance between the first feature point O and the second feature point C may be in a range of 16.5 mm-20.5 mm. Merely by way of example, the distance between the first feature point O and the second feature point C may be 17.3 mm.

Referring to FIG. 4 and FIG. 6, in some embodiments, when the sound production portion 11 is not in contact with the abutting portion 12, in the direction of the shortest connecting line O₁O₂, the second feature point C and the abutting portion 12 are located on a same side of the first feature point O. In some embodiments, in the wearing state, the second feature point C may correspond to a position on the helix at the farthest point from the concha cavity. The position of the second feature point C may be designed so that the portion of the ear hook 13 near the abutting portion 12 undergoes a more abrupt shift, while the portion of the ear hook 13 near the sound production portion 11 undergoes a relatively gentle change. That is, on the third projection 13′, a change rate of the inner contour curve from the second feature point C to the second projection 12′ is significantly greater than a change rate of the inner contour curve from the second feature point C to the first projection 11′, so as to allow the ear hook 13 to be asymmetrically set. As shown in FIG. 3A and FIG. 3B, the change gradient of the front side of the auricle from the concha cavity to the helix is significantly smaller compared to that of the rear side of the auricle from the helix to the back side of the concha cavity. In order to better accommodate this change of the auricle, by asymmetrically setting the ear hook 13, the ear hook 13 may be made to correspond to the change from the helix to the rear side of the auricle and to the concha cavity, avoiding the ear hook 13 interfering with the helix, and improving the wearing comfort of the earphone 10.

In some embodiments, when the sound production portion 11 is not in contact with the abutting portion 12, the shortest connecting line O₁O₂ may be parallel or substantially parallel to the connecting line AB. That is, a direction of a straight line in which the shortest connecting line O₁O₂ is located may also be replaced with a direction in which the reference connecting line L₁ is located. Correspondingly, when the sound production portion 11 comes in contact with the abutting portion 12, in the direction of the reference connecting line L₁, the second feature point C and the abutting portion 12 are located on the same side of the point O.

In some embodiments, when the sound production portion 11 is not in contact with the abutting portion 12, by adjusting the positions and distances of the first feature point O and the second feature point C in a direction of a straight line where the shortest connecting line O₁O₂ is located, the design requirement for the deviation of the second feature point C from the first feature point O may be achieved, so that the ear hook 13 may correspond to the changes between the helix to the rear side of the auricle and to the concha cavity, avoiding the ear hook 13 interfering with the helix, and improving the wearing comfort of the earphone 10.

In the direction of the shortest connecting line O₁O₂, if the distance between the first feature point O and the second feature point C (i.e., the length of a projection of the line segment OC on the line where the shortest connecting line O₁O₂ is located) is too large, it indicates that the deviation of the second feature point C from the first feature point O is too large, with the point C serving as the boundary, the portion of the ear hook 13 close to the abutting portion 12 is too small, meaning that in the wearing state, the portion of the ear hook 13 close to the abutting portion 12 may interfere with a portion of the rear side of the auricle on the ear. In the direction of the shortest connecting line O₁O₂, if the distance between the first feature point O and the second feature point C is too small, it indicates that the deviation of the second feature point C from the first feature point O is too small, with the point C serving as the boundary, the portion of the ear hook 13 that is close to the sound production portion 11 is too small, meaning that in the wearing state, the portion of the ear hook 13 close to the sound production portion 11 may interfere with the portion of the front side of the auricle on the ear. The interference between the ear hook 13 and the ear may affect the wearing comfort and the clamping effect of the earphone 10.

In some embodiments, when the sound production portion 11 is not in contact with the abutting portion 12 as shown in FIG. 4, in order to avoid the interference between the ear hook 13 and the user's ear, and to enhance the wearing comfort and the clamping effect of the earphone 10, a distance between the first feature point O and the second feature point C along the direction of the shortest connecting line O₁O₂ may be in a range of 8.2 mm-11 mm. In some embodiments, in order to further reduce the possibility of interference between the ear hook 13 and the front side of the auricle, the distance between the first feature point O and the second feature point C in the direction of the shortest connecting line O₁O₂ may be in a range of 8.7 mm-10.5 mm. In some embodiments, in order to further reduce the possibility of interference between the ear hook 13 and the rear side of the auricle, the distance between the first feature point O and the second feature point C in the direction of the shortest connecting line O₁O₂ may be in a range of 9 mm-10 mm. For example, the distance between the first feature point O and the second feature point C in the direction of the shortest connecting line O₁O₂ may be 9.9 mm.

Correspondingly, when the sound production portion 11 comes into contact with the abutting portion 12 as shown in FIG. 6, the distance between the first feature point O and the second feature point C in the direction where the reference connecting line L₁ is located may be in a range of 7.5 mm-10 mm. Exemplarily, in the direction in which the reference connecting line L₁ is located, the distance between the first feature point O and the second feature point C may be 9.1 mm.

A line connecting the first feature point O and the second feature point C is defined as a first connecting line. In some embodiments, when the sound production portion 11 is not in contact with the abutting portion 12 as shown in FIG. 4, an angle between the first connecting line OC and the shortest connecting line O₁O₂ (i.e., ∠COO₂) may be 50°-70°. By designing the angle between the first connecting line OC and the shortest connecting line O₁O₂, the position of the second feature point C with respect to the first feature point O may be adjusted to adjust the shape of the ear hook 13, so that the ear hook 13 may be adapted to more different ear sizes, thereby avoiding interference between the ear hook 13 and the ear, and ensuring the wearing comfort and clamping effect of the earphone 10. In some embodiments, if the angle between the first connecting line OC and the shortest connecting line O₁O₂ is too large, it indicates that the deviation of the second feature point C from the first feature point O is too small, with the point C as the boundary, the portion of the ear hook 13 close to the sound production portion 11 is too small, meaning that in the wearing state, the portion of the ear hook 13 close to the sound production portion 11 may interfere with the portion of the front side of the auricle on the ear. If the angle between the first connecting line OC and the shortest connecting line O₁O₂ is too small, it indicates that the deviation of the second feature point C from the first feature point O is too large, with the point C as the boundary, the portion of the ear hook 13 close to the abutting portion 12 is too small, meaning that in the wearing state, the portion of the ear hook 13 close to the abutting portion 12 may interfere with a portion of the rear side of the auricle on the ear.

In order to further reduce the possibility of interference between the ear hook 13 and the front side of the auricle, in some embodiments, when the sound production portion 11 is not in contact with the abutting portion 12 as shown in FIG. 4, the angle (i.e., ∠COO₂) between the first connecting line OC and the shortest connecting line O₁O₂ may be 50°-65°. In some embodiments, to further avoid the interference between the ear hook 13 and the rear side of the auricle, the angle between the first connecting line OC and the shortest connecting line O₁O₂ (i.e., ∠COO₂) may be 52°-60°. Exemplarily, the angle between the first connecting line OC and the shortest connecting line O₁O₂ (i.e., ∠COO₂) may be 58°.

Correspondingly, when the sound production portion 11 comes into contact with the abutting portion 12 as shown in FIG. 6, an angle (angle α as shown in FIG. 6) between the first connecting line OC and the reference connecting line L₁ may be 45°-60°. Exemplarily, the angle (angle α as shown in FIG. 6) between the first connecting line OC and the reference connecting line L₁ may be 55°.

In some embodiments, the second feature point C is a protruding point of the ear hook 13, and the stress on the ear hook 13 is relatively high at the second feature point C. To avoid over-concentration of stress in the region of the ear hook 13 and to improve its service life, a protrusion degree of the third projection 13′ near the second feature point C should not be too large. But if the protrusion degree of the third projection 13′ near the second feature point C is too small, it will affect the overall structure and size of the earphone 10, and may lead to interference between the ear hook 13 and the user's ear, affecting the wearing stability of the earphone 10.

In some embodiments, in order to characterize the protrusion degree of the ear hook 13 near the second feature point C, two arc segments (e.g., an arc CT₁, an arc CT₂) with equal arc lengths may be defined on the inner contour curve of the third projection 13′, symmetrically positioned on either side of point C. The connecting line between the ends of the two arc segments (e.g., the arc CT₁, the arc CT₂) away from the second feature point C is referred to as a connecting line T₁T₂, and the arc segment corresponding to the connecting line T₁T₂ is an arc T₁T₂. An arc-string-ratio between the arc length of the arc T₁T₂ and the length of the connecting line T₁T₂ may indicate the degree of curvature of the arc T₁T₂, thereby indicating the protrusion degree of the inner contour curve at the corresponding position of the arc T₁T₂.

In some embodiments, in order to accurately characterize the protrusion degree of the ear hook 13 near the second feature point C, points T₁ and T₂ should not be too close to or too far from the second feature point C. In some embodiments, when the sound production portion 11 is not in contact with the abutting portion 12 as shown in FIG. 4 or when the sound production portion 11 comes into contact with the abutting portion 12 as shown in FIG. 6, the arc lengths of the arc CT₁ and the arc CT₂ may be in a range of 2.5 mm-3.5 mm. In some embodiments, in order to further enhance the accuracy of the characterization of the protrusion degree of the ear hook 13 near the second feature point C, a preset arc length range may be 2.7 mm-3.2 mm.

In some embodiments, when the sound production portion 11 is not in contact with the abutting portion 12 as shown in FIG. 4, in order to avoid over-concentration of stress in the region of the ear hook 13, and at the same time to ensure the stability of the earphone 10 for wearing, the arc-string-ratio between the arc length of the arc T₁T₂ and the length of the connecting line T₁T₂ may be in a range of 1.00-1.10. In some embodiments, to further avoid over-concentration of stress in the region of the ear hook 13, and to prolong the service life of the ear hook 13, the arc-string-ratio between the arc length of the arc T₁T₂ and the length of the connecting line T₁T₂ may be in a range of 1.01-1.07. Exemplarily, the arc-string-ratio between the arc length of the arc T₁T₂ and the length of the connecting line T₁T₂ may be 1.04.

In some embodiments, when the sound production portion 11 comes in contact with the abutting portion 12 as shown in FIG. 6, the arc-string-ratio between the arc length of the arc T₁T₂ and the length of the connecting line T₁T₂ may be in a range of 1.03-1.12. Exemplarily, the arc-string-ratio between the arc length of the arc T₁T₂ and the length of the connecting line T₁T₂ may be 1.06.

Referring to FIG. 4 and FIG. 6, in some embodiments, in a vertical direction of the first connecting line OC, a portion of the outer contour of the earphone 10 near the first projection 11′ has a first tangent line L₂ parallel to the first connecting line OC, and a portion of the outer contour of the earphone 10 near the second projection 12′ has a second tangent line L₃ parallel to the first connecting line OC. In some embodiments, the portion of the earphone 10 between the first connecting line OC and the first tangent line L₂ may correspond to the change in the ear from the helix to the concha cavity, and the portion of the earphone 10 between the first connecting line OC and the second tangent line L₃ may correspond to the change in the ear from the helix to the back of the auricle.

If a distance d₁ between the first connecting line OC and the first tangent line L₂ is too small, it may result in an interference between the ear hook 13 and the front side of the auricle. If the distance d₁ between the first connecting line OC and the first tangent line L₂ is too large, it may result in the sound production portion 11 interfering with the tragus. In some embodiments, when the sound production portion 11 comes into contact with the abutting portion 12 as shown in FIG. 6, in order to avoid the interference between the earphone 10 and the user's ear, the distance d₁ between the first connecting line OC and the first tangent line L₂ may be in a range of 12 mm-15.5 mm. In some embodiments, in order to further reduce the possibility of the interference between the sound production portion 11 and the tragus, the distance d₁ between the first connecting line OC and the first tangent line L₂ may be in a range of 13 mm-15 mm. In some embodiments, in order to further reduce the possibility of the interference between the ear hook 13 and the front side of the auricle, the distance d₁ between the first connecting line OC and the first tangent line L₂ may be in a range of 13.5 mm-14.6 mm. Exemplarily, the distance d₁ between the first connecting line OC and the first tangent line L₂ may be 13.6 mm.

In some embodiments, when the sound production portion 11 is not in contact with the abutting portion 12 as shown in FIG. 4, the distance d₁ between the first connecting line OC and the first tangent line L₂ may be in a range of 13 mm-16 mm. Exemplarily, the distance d₁ between the first connecting line OC and the first tangent line L₂ may be 14.4 mm.

If a distance d₂ between the first connecting line OC and the second tangent line L₃ is too small, it may result in an interference between the ear hook 13 and the back of the auricle. If the distance d₂ between the first connecting line OC and the second tangent line L₃ is too large, it may result in the interference between the abutting portion 12 and the head skin on the back of the auricle of the user, and may also cause the abutting portion 12 to excessively squeeze the head skin on rear side of the auricle of the user.

In some embodiments, when the sound production portion 11 comes into contact with the abutting portion 12 as shown in FIG. 6, in order to avoid the interference between the earphone 10 and the user's ear, and the interference between the earphone 10 and the head skin in the vicinity of the ear, the distance d₂ between the first connecting line OC and the second tangent line L₃ may be in a range of 10.5 mm-13 mm. In some embodiments, in order to further avoid the interference between the ear hook 13 and the back of the auricle, the distance d₂ between the first connecting line OC and the second tangent line L₃ may be in a range of 11 mm-12.5 mm. In some embodiments, in order to further avoid the interference between the abutting portion 12 and the head skin on the back of the user's auricle, the distance d₂ between the first connecting line OC and the second tangent line L₃ may be in a range of 11.5 mm-12 mm. Exemplarily, the distance d₂ between the first connecting line OC and the second tangent line L₃ may be 11.6 mm.

In some embodiments, when the sound production portion 11 is not in contact with the abutting portion 12 as shown in FIG. 4, the distance d₂ between the first connecting line OC and the second tangent line L₃ may be in a range of 10 mm-12.5 mm. Exemplarily, the distance d₂ between the first connecting line OC and the second tangent line L₃ may be 11.5 mm.

The second projection 12′ has a centroid point F, and the centroid point F of the second projection 12′ may be defined as a third feature point. In some embodiments, when the sound production portion 11 is not in contact with the abutting portion 12 as shown in FIG. 4, the straight line in which the shortest connecting line O₁O₂ is located has two intersection points with the second projection 12′, and the third feature point F may be the midpoint of the two intersection points. In some embodiments, when the sound production portion 11 comes into contact with the abutting portion 12 as shown in FIG. 6, a parallel line of the reference connecting line L₁ passes through the first feature point O, this parallel line has two intersection points with the second projection 12′, and the third feature point F may be the midpoint of the two intersection points. In some embodiments, the centroid of the second projection 12′ may refer to the centroid of the projection of the internal cavity of the abutting portion 12 on the first symmetry plane S1, i.e., the centroid of the inner contour of the second projection 12′, as shown in FIG. 4 or FIG. 6.

In some embodiments, when the sound production portion 11 is not in contact with the abutting portion 12 as shown in FIG. 4, in the direction of the shortest connecting line O₁O₂, the second feature point C is farther away from the first feature point O than the third feature point F, so that the asymmetry of the ear hook 13 can ensure that the ear hook 13 can correspond to the changes between the helix to the back of the auricle and to the concha cavity, avoiding the ear hook 13 interfering with the front side of the auricle and the back of the auricle, and improving the wearing comfort of the earphone 10.

Correspondingly, when the sound production portion 11 comes into contact with the abutting portion 12 as shown in FIG. 6, the second feature point C is farther away from the first feature point O in the direction of the reference connecting line L₁ as compared to the third feature point F.

In some embodiments, if an angle (i.e., ∠COF) between the connecting line OF (i.e., a line connecting the third feature point F and the first feature point O) and the first connecting line OC is too large, it indicates that the deviation of the second feature point C from the first feature point O is too small, with the point C serving as the boundary, the portion of the ear hook 13 close to the sound production portion 11 is too small, meaning that in the wearing state, the portion of the ear hook 13 close to the sound production portion 11 may interfere with the front side of the auricle on the ear. If the angle between the connecting line OF and the first connecting line OC is too small, it indicates that the deviation of the second feature point C from the first feature point O is too large, and with the point C serving as the boundary, the portion of the ear hook 13 close to the abutting portion 12 is too small, meaning that in the wearing state, the portion of the ear hook 13 close to the abutting portion 12 may interfere with a portion of the rear side of the auricle on the ear.

In some embodiments, when the sound production portion 11 comes into contact with the abutting portion 12 as shown in FIG. 6, in order to avoid the interference between the ear hook 13 and the user's ear, the angle (i.e., ∠COF) between the connecting line OF and the first connecting line OC may be in a range of 45°-65°. In some embodiments, in order to further reduce the possibility of interference between the ear hook 13 and the front side of the auricle, the angle between the connecting line OF and the first connecting line OC may be in a range of 50°-60°. In some embodiments, to further reduce the possibility of interference between the ear hook 13 and the rear side of the auricle, the angle between the connecting line OF and the first connecting line OC may be in a range of 52°-55°. Exemplarily, the angle between the connecting line OF and the first connecting line OC may be 53°.

In some embodiments, when the sound production portion 11 is not in contact with the abutting portion 12 as shown in FIG. 4, the angle between the connecting line OF and the first connecting line OC may be in a range of 42°-62°. Exemplarily, the angle (i.e., COF) between the connecting line OF and the first connecting line OC may be 50°.

In some embodiments, a line passing through the second feature point C and biased towards the first projection 11′ may be defined as a first auxiliary line L₄. A first angle between the first auxiliary line L₄ and the first connecting line (i.e., the connecting line OC) has a first preset value range. An intersection point E between the inner contour curve of the third projection 13′ and the first auxiliary line L₄ may be defined as a fourth feature point. The connecting line CE connecting the fourth feature point E to the second feature point C is the second connecting line, and the second connecting line (i.e., the connecting line CE) is collinear with the first auxiliary line L₄. In some embodiments, the fourth feature point E may be a demarcation point between the inner contour curve of the third projection 13′ and the inner contour of the first projection 11′. The portion of the ear hook 13 corresponding to the second connecting line CE (e.g., a portion corresponding to an arc CE) is provided on the side where the second connecting line CE departs from the abutting portion 12 to avoid the interference between the ear hook 13 and the helix or the antihelix.

In some embodiments, if the first angle (i.e., ∠COF) between the second connecting line CE and the first connecting line OC is too small, it may cause the inner contour of the portion of the ear hook 13 corresponding to the second connecting line CE to interfere with or squeeze the portion of the user's ear extending from the helix to the concha cavity. If the first angle between the second connecting line CE and the first connecting line OC is too large, it may result in the size of the ear hook 13 being too large, and cause the sound production portion 11 to interfere with the tragus of the user or blocking the ear canal opening of the user.

In some embodiments, when the sound production portion 11 is not in contact with the abutting portion 12 as shown in FIG. 4, in order to avoid the sound production portion 11 blocking the ear canal opening of the user, and to prevent the sound production portion 11 from interfering with the tragus, the helix, or the antihelix, the first preset value range may be 30°-40°, i.e., the first angle between the second connecting line CE and the first connecting line OC may be in a range of 30°-40°. In some embodiments, in order to further prevent the sound production portion 11 from interfering with the tragus or blocking the ear canal opening, the first angle between the second connecting line CE and the first connecting line OC may be in a range of 32°-37°. In some embodiments, in order to further avoid the interference between the sound production portion 11 and the helix or the antihelix, the first angle between the second connecting line CE and the first connecting line OC may be 36°.

In some embodiments, when the sound production portion 11 comes into contact with the abutting portion 12 as shown in FIG. 6, the angle between the second connecting line CE and the first connecting line may be in a range of 27°-37°. Exemplarily, the angle between the second connecting line CE and the first connecting line may be 33°.

In some embodiments, if a distance between the fourth feature point E and the second feature point C (i.e., the length of the second connecting line CE) is too large, it may result in the size of the ear hook 13 being too large, so that the sound production portion 11 interferes with the user's tragus or is too close to or even blocks the ear canal opening. If the distance between the fourth feature point E and the second feature point C is too small, it may cause the inner contour of the portion of the ear hook 13 corresponding to the second connecting line CE to interfere with or squeeze the portion of the user's ear extending from the helix to the concha cavity.

In some embodiments, when the sound production portion 11 is not in contact with the abutting portion 12 as shown in FIG. 4, in order to avoid the sound production portion 11 blocking the ear canal opening of the user, and to prevent the sound production portion 11 from interfering with the tragus, the helix, or the antihelix, the length of the second connecting line CE may be in a range of 16 mm-22 mm. In some embodiments, in order to further prevent the sound production portion 11 from interfering with the tragus or blocking the ear canal opening, the length of the second connecting line CE may be in a range of 16.5 mm-21 mm. In some embodiments, in order to further prevent the sound production portion 11 from interfering with the helix or the antihelix, the length of the second connecting line CE may be in a range of 17 mm-20 mm. Exemplarily, the length of the second connecting line CE may be 17.8 mm.

In some embodiments, when the sound production portion 11 comes in contact with the abutting portion 12 as shown in FIG. 6, the length of the second connecting line CE may be in a range of 15.5 mm-21.5 mm. Exemplarily, the length of the second connecting line CE may be 17.2 mm.

In some embodiments, the portion (i.e., the arc CE) of the inner contour curve of the third projection 13′ corresponding to the second connecting line CE has a first arc length, and a ratio of the first arc length to a length of the second connecting line CE is defined as a first arc-string-ratio. The first arc-string-ratio may reflect the degree of flatness of the arc CE corresponding to the second connecting line CE. The greater the first arc-string-ratio, the greater the protrusion degree of the arc CE corresponding to the second connecting line CE, the greater an area of a region within the arc CE, and the less likely that the portion corresponding to the ear hook 13 will interfere with the portion of the ear extending from the helix to the concha cavity. The smaller the first arc-string-ratio, the flatter the arc CE corresponding to the second connecting line CE, the smaller the area of the region within the arc CE, and the more likely that the portion corresponding to the ear hook 13 may interfere with the portion of the ear extending from the helix to the concha cavity (e.g., the helix and the antihelix). In some embodiments, when the sound production portion 11 is not in contact with the abutting portion 12 as shown in FIG. 4, in order to avoid the ear hook 13 interfering with the helix and the antihelix, the first arc-string-ratio may be greater than 1.05.

If the first arc-string-ratio is too large, it may result in the size of the ear hook 13 being too large, resulting in the overall size of the earphone 10 being too large, which affects the wearing effect and reduces portability. In some embodiments, when the sound production portion 11 is not in contact with the abutting portion 12 as shown in FIG. 4, in order to make the overall size of the earphone 10 suitable, the first arc-string-ratio may be less than 1.20, i.e., the first arc-string-ratio may be in a range of 1.05-1.20. In some embodiments, in order to further reduce the overall size of the earphone 10, the first arc-string-ratio may be in a range of 1.08-1.17. In some embodiments, to further avoid the interference between the ear hook 13 and the ear, the first arc-string-ratio may be in a range of 1.10-1.15. Exemplarily, the first arc-string-ratio may be 1.13.

In some embodiments, when the sound production portion 11 comes into contact with the abutting portion 12 as shown in FIG. 6, the first arc-string-ratio may be in a range of 1.10-1.25. Exemplarily, the first arc-string-ratio may be 1.14.

In some embodiments, a portion (i.e., the arc CE) of the inner contour curve corresponding to the second connecting line CE may be defined as a first arc segment. A distance between the first arc segment and the second connecting line CE is minimum (equal to zero) at the two endpoints (point C and point E), and maximum at the vertex of the arc CE. The maximum distance between the first arc segment and the second connecting line CE may reflect the degree of flatness of the arc CE. If the maximum distance is too large, the protrusion degree of the arc CE is too large, the size of the ear hook 13 is too large, and the overall size of the earphone 10 is too large, which affects the wearing effect and reduces portability of the earphone 10.

In some embodiments, when the sound production portion 11 is not in contact with the abutting portion 12 as shown in FIG. 4, to avoid the first arc segment of the ear hook 13 protruding too much, the distance from the second connecting line CE to the first arc segment (i.e., the arc CE) may be no greater than 3.4 mm. In some embodiments, in order to further avoid that the size of the ear hook 13 is too large to affect the wearing effect of the earphone 10, the distance from the second connecting line CE to the first arc segment (i.e., the arc CE) may be no greater than 3.0 mm. In some embodiments, to further avoid the ear hook 13 being oversized, the distance from the second connecting line CE to the first arc segment (i.e., the arc CE) may be no greater than 2.8 mm.

In some embodiments, when the sound production portion 11 comes into contact with the abutting portion 12 as shown in FIG. 6, the distance from the second connecting line CE to the first arc segment (i.e., the arc CE) may be no greater than 3.2 mm.

In some embodiments, a line passing through the second feature point C and biased towards the second projection 12′ is defined as a second auxiliary line L₅. A second angle between the second auxiliary line L₅ and the first connecting line OC has a second preset value range. An intersection point H between a curve segment, which is on the inner contour curve of the third projection 13′ and connected to the second projection 12′, and the second auxiliary line L₅ may be defined as a fifth feature point H. A line connecting the fifth feature point H and the second feature point C is defined to as a fourth connecting line CH, which is collinear with the second auxiliary line L₅. In some embodiments, the fifth feature point H may be a demarcation point between the inner contour curve of the third projection 13′ and the inner contour of the third projection 13′.

In some embodiments, if the second angle (i.e., OCH) between the fourth connecting line CH and the first connecting line OC is too small, it may result in the abutting portion 12 overly squeezing the rear side of the auricle of the user. If the second angle between the fourth connecting line CH and the first connecting line OC is too large, it may result in the ear hook 13 being oversized, and may cause the abutting portion 12 to interfere with the head skin tissue on the rear side of the auricle of the user.

In some embodiments, when the sound production portion 11 is not in contact with the abutting portion 12 as shown in FIG. 4, in order to avoid excessive squeezing of the ear by the abutting portion 12, and to prevent the abutting portion 12 from interfering with the head skin of the user, the second angle between the fourth connecting line CH and the first connecting line OC may be in a range of 35°-50°. In some embodiments, in order to further avoid excessive squeezing of the ear by the abutting portion 12, the second angle between the fourth connecting line CH and the first connecting line OC may be in a range of 36°-43°. In some embodiments, to further avoid the interference between the abutting portion 12 and the head skin of the user, the second angle between the fourth connecting line CH and the first connecting line OC may be in a range of 38°-42°. Exemplarily, the second angle between the fourth connecting line CH and the first connecting line OC may be in a range of 41°.

In some embodiments, when the sound production portion 11 comes in contact with the abutting portion 12 as shown in FIG. 6, the angle between the fourth connecting line CH and the first connecting line OC may be in a range of 34°-49°. Exemplarily, the angle between the fourth connecting line CH and the first connecting line OC may be 40°.

In some embodiments, if a distance (i.e., the length of the fourth connecting line CH) between the fifth feature point H and the second feature point C is too large, it may result in the size of the ear hook 13 being too large and the overall size of the earphone 10 being too large, which may affect the wearing effect and reduce portability of the earphone 10. If the distance between the fifth feature point H and the second feature point C is too small, it may cause the interference between the ear hook 13 and the rear side of the auricle, and it may also cause misalignment of the abutting portion 12 disposed at the rear side of the auricle with the sound production portion 11 disposed in the concha cavity, thereby affecting the clamping firmness between the abutting portion 12 and the sound production portion 11, affecting the wearing stability of the earphone 10.

In some embodiments, when the sound production portion 11 is not in contact with the abutting portion 12 as shown in FIG. 4, in order to avoid that the size of the ear hook 13 is too large to affect the wearing effect, and to avoid that the ear hook 13 interferes with the rear side of the auricle, and to avoid that the abutting portion 12 and the sound production portion 11 are misaligned, and to enhance the wearing stability of the earphone 10, the length of the fourth connecting line CH may be in a range of 7 mm-9 mm. In some embodiments, in order to further avoid that the size of the ear hook 13 is too large, the length of the fourth connecting line CH may be in a range of 7.2 mm-8.6 mm. In some embodiments, in order to further enhance the wearing stability and wearing comfort of the earphone 10, the length of the fourth connecting line CH may be in a range of 7.4 mm-8.2 mm. Exemplarily, the length of the fourth connecting line CH may be 7.6 mm.

In some embodiments, when the sound production portion 11 comes into contact with the abutting portion 12 as shown in FIG. 6, the length of the fourth connecting line CH may be in a range of 7.2 mm-9.2 mm. Exemplarily, the length of the fourth connecting line CH may be 7.8 mm.

In some embodiments, the portion (i.e., the arc CH) of the inner contour curve of the third projection 13′ corresponding to the fourth connecting line CH has a third arc length, and a ratio of the third arc length to a length of the fourth connecting line CH may be defined as a third arc-string-ratio. The third arc-string-ratio may reflect the degree of flatness of the arc CH corresponding to the fourth connecting line CH. The greater the third arc-string-ratio, the greater the protrusion degree of the arc CH corresponding to the fourth connecting line CH, the greater an area of a region within the arc CH, and the more likely that the abutting portion 12 and the ear hook 13 will rest against the skin of the head on the rear side of the auricle. The smaller the third arc-string-ratio, the flatter the arc CH corresponding to the fourth connecting line CH, the smaller the area of the region within the arc CH, and the more likely that the portion corresponding to the ear hook 13 may interfere with a portion (e.g., an outermost point of the helix) of the ear extending from the helix to the rear side of the auricle.

In some embodiments, when the sound production portion 11 is not in contact with the abutting portion 12 as shown in FIG. 4, in order to avoid the ear hook 13 interfering with the ear, and to prevent the abutting portion 12 and the ear hook 13 from squeezing the head skin on the rear side of the auricle of the user, the third arc-string-ratio may be in a range of 1.10-1.23. In some embodiments, in order to further avoid the interference between the ear hook 13 and the ear, the second arc-string-ratio may be in a range of 1.13-1.20. In some embodiments, to further prevent the abutting portion 12 from squeezing the head skin on the rear side of the auricle of the user, the third arc-string-ratio may be in a range of 1.15-1.19. Exemplarily, the third arc-string-ratio may be 1.18.

Additionally, by setting the range of the third arc-string-ratio, the arc CH may have a higher protrusion degree, thereby distinguishing it from the relatively flatter the arc segment CE. That is, the curve on the side of the ear hook 13 connected to the sound production portion 11 is relatively flat, while the curve on the other side of the ear hook 13 connected to the abutting portion 12 is more protruding, thereby facilitating the user recognition of the wearing direction and preventing incorrect wearing.

In some embodiments, when the sound production portion 11 comes into contact with the abutting portion 12 as shown in FIG. 6, the third arc-string-ratio may be in a range of 1.11-1.24. Exemplarily, the third arc-string-ratio may be 1.17.

Referring to FIG. 4, in some embodiments, when the sound production portion 11 is not in contact with the abutting portion 12 as shown in FIG. 4, an extension line of the shortest connecting line O₁O₂ can be made, which intersects with the first projection 11′ at points O₁ and G, with G as a sixth feature point. In some embodiments, a distance between the first feature point O and the sixth feature point G (i.e., the length of the connecting line OG) may reflect the dimension of the sound production portion 11. If the distance between the first feature point O and the sixth feature point G is too large, it means that the size of the sound production portion 11 is too large, and the sound production portion 11 is prone to interfering with the tragus and squeezing the tragus. If the distance between the first feature point O and the sixth feature point G is too small, it indicates that the size of the sound production portion 11 is too small, and that the pressure inside the concha cavity is too large in the wearing state, which will reduce the sound-producing efficiency of the sound production portion 11.

In some embodiments, when the sound production portion 11 is not in contact with the abutting portion 12 as shown in FIG. 4, in order to prevent the sound production portion 11 from squeezing the tragus, and at the same time to make the size of the sound production portion 11 appropriate and to enhance the sound-producing efficiency of the sound production portion 11, the distance between the first feature point O and the sixth feature point G may be in a range of 12 mm-15 mm. In some embodiments, in order to further prevent the sound production portion 11 from squeezing the tragus, the distance between the first feature point O and the sixth feature point G may be in a range of 12.5 mm-14 mm. In some embodiments, in order to further make the size of the sound production portion 11 appropriate, the distance between the first feature point O and the sixth feature point G may be 13.5 mm.

In some embodiments, when the sound production portion 11 comes in contact with the abutting portion 12 as shown in FIG. 6, a parallel line of the connecting line AB (i.e., the straight line L₁) may pass through the point O, which intersects the first projection 11′ at the points O and G, so as to determine the position of the sixth feature point G. In some embodiments, when the sound production portion 11 comes in contact with the abutting portion 12 as shown in FIG. 6, the distance between the first feature point O and the sixth feature point G may be in a range of 10.5 mm-15.5 mm. Exemplarily, the distance between the first feature point O and the sixth feature point G may be 13.0 mm.

Referring to FIG. 2, FIG. 3A, FIG. 3B, FIG. 4, and FIG. 6, in some embodiments, the housing of the sound production portion 11 may also be provided with a pressure relief hole (not shown in the figures). The sound outlet 111 and the pressure relief hole are acoustically coupled to acoustic chambers on both sides of the diaphragm of the sound production assembly, respectively, so as to respectively derive the sound of the corresponding acoustic chambers. In some embodiments, a line connecting the centroid of the pressure relief hole to the centroid (the point J) of the sound outlet 111 may point toward the ear canal opening of the user to enhance the acoustic directivity of the sound production assembly. Optionally, the pressure relief hole may be provided near the location where the housing of the sound production portion 11 is connected to the ear hook 13. Correspondingly, the position of the projection of the pressure relief hole on the first symmetry plane S1 is near the position where the inner contour of the first projection 11′ is connected to the inner contour of the third projection 13′. That is, the position of the projection of the pressure relief hole on the first symmetry plane S1 is located near the fifth feature point E on the inner contour of the first projection 11′ or on the inner contour curve of the third projection 13′.

On the inner contour curve of the third projection 13′ and the inner contour of the first projection 11′, with the fourth feature point E as a center, a second arc segment (i.e., an arc EP₁) and a third arc segment (i.e., an arc EP₂) are determined on both sides of the fourth feature point E. An arc length of the second arc segment (i.e., the arc EP₁) and an arc length of the third arc segment (i.e., the arc EP₂) are within a preset arc length range, and a line connecting an end (i.e., a point P₁) of the second arc segment (i.e., the arc EP₁) away from the fourth feature point E and the an end of the third arc segment (i.e., a point P₂) away from the fourth feature point E is defined as the third connecting line (i.e., a line P₁P₂). In some embodiments, the projection of the pressure relief hole on the first symmetry plane S1 may be provided in an arc segment corresponding to the third connecting line P₁P₂ (i.e., the arc P₁P₂). In some embodiments, the projection of the pressure relief hole on the first symmetry plane S1 may be provided in a portion of the arc P₁P₂ lying on the contour of the first projection 11′ (e.g., the arc EP₁ shown in FIG. 4 and FIG. 6). In some embodiments, the outer contour of the projection of the pressure relief hole on the first symmetry plane S1 has two endpoints, and in FIG. 6, for example, points Q₁ and Q₂ shown in FIG. 6 are the aforementioned two endpoints, and the opening between the points Q₁ and Q₂ is the outer contour of the projection of the pressure relief hole. In some embodiments, in order to make the arc P₁P₂ continuous, the points Q₁ and Q₂ may be connected to represent the arc Q₁Q₂ by the connecting line Q₁Q₂.

The arc P₁P₂ has a second arc length. The second arc length is a sum of the arc length of the second arc segment (i.e., the arc EP₁) and the arc length of the third arc segment (i.e., the arc EP₂). In order to make the pressure relief hole have enough setting space, the second arc length of the arc P₁P₂ should not be too small. In order to avoid the position of the pressure relief hole being deviated, which affects the directivity of the sound production portion 11, the second arc length of the arc P₁P₂ should not be too large. In some embodiments, when the sound production portion 11 is not in contact with the abutting portion 12 as shown in FIG. 4 or when the sound production portion 11 comes into contact with the abutting portion 12 as shown in FIG. 6, the preset arc length range may be 2.5 mm-3.5 mm. In some embodiments, in order to further provide a suitable setting position for the pressure relief hole, the preset arc length range may be 2.7 mm-3.2 mm.

In some embodiments, a ratio of the second arc length of the arc P₁P₂ corresponding to the third connecting line P₁P₂ to a length of the third connecting line P₁P₂ is defined as a second arc-string-ratio. The greater the second arc-string-ratio, the greater the degree of curvature of the arc P₁P₂, and the greater the degree of depression of the inner contour near the connection position between the sound production portion 11 and the ear hook 13 corresponding to the arc P₁P₂. The smaller the second arc-string-ratio, the flatter the arc P₁P₂, and the lower the degree of depression of the inner contour near the connection position between the sound production portion 11 and the ear hook 13 corresponding to the arc P₁P₂.

In some embodiments, since the projection of the pressure relief hole on the first symmetry plane S1 is located on the arc P₁P₂, in order to prevent the pressure relief hole from being obscured by the auricle in the wearing state, the degree of curvature of the arc P₁P₂ should be greater than a certain threshold. This ensures the inner contour near the connection position between the sound production portion 11 and the ear hook 13 corresponding to the arc P₁P₂ has sufficient depression so that the pressure relief hole provided at the recessed position may not be obstructed by the auricle.

In some embodiments, when the sound production portion 11 is not in contact with the abutting portion 12 as shown in FIG. 4, in order to avoid that the pressure relief hole is obstructed by the auricle, the second arc-string-ratio is greater than 1.26. In some embodiments, in order to prevent the connection position between the sound production portion 11 and the ear hook 13 from being too thin, which affects the strength of the connection position, and the recessed position should not be too deep, the second arc-string-ratio may be less than 1.44, i.e., the second arc-string-ratio may be in a range of 1.26-1.44. In some embodiments, to ensure that the recessed position has sufficient depth to avoid the pressure relief hole being obscured by the auricle, the third arc-string-ratio may be in a range of 1.29-1.40. In some embodiments, in order to prevent the connection position between the sound production portion 11 and the ear hook 13 from being too thin, which affects the strength of the connection position, the second arc-string-ratio may be in a range of 1.33-1.38. Exemplarily, the second arc-string-ratio may be 1.35.

In some embodiments, when the sound production portion 11 comes in contact with the abutting portion 12 as shown in FIG. 6, the morphology of the arc P₁P₂ may be the same as or nearly the same as the morphology in the non-contact state as shown in FIG. 4, and the third arc-string-ratio may be in a range of 1.26-1.44. Exemplarily, the third arc-string-ratio may be 1.35.

In some embodiments, when the sound production portion 11 is not in contact with the abutting portion 12 as shown in FIG. 4, an endpoint of the shortest connecting line O₁O₂ on the first projection 11′ is the point O₁, and an endpoint of the arc P₁P₂ near the first projection 11′ is the point P₁. In the wearing state, the portion of the inner contour of the first projection 11′ between the point O₁ and the point P₁ (i.e., an arc O₁P₁) is at least partially in contact with the concha cavity, thereby isolating the sound outlet 111 from the pressure relief hole, and avoiding the generation of an acoustic short circuit (i.e., the sound from the sound outlet and the pressure relief hole interfering with and canceling each other at the ear canal) to affect the sound production effect of the sound production portion 11.

In some embodiments, when the sound production portion 11 comes in contact with the abutting portion 12 as shown in FIG. 6, the portion between the first feature point O and the point P₁ (i.e., an arc OP₁) is at least partially in contact with the concha cavity in the wearing state, thereby isolating the sound outlet 111 from the pressure relief hole, and avoiding the generation of the acoustic short circuit to affect the sound production effect of the sound production portion 11.

In some embodiments, a point N closest to the second feature point C on the first projection 11′ may be defined as a seventh feature point, and a line CN connecting the second feature point C to the seventh feature point N is defined as a fifth connecting line. If the length of the fifth connecting line CN is too large, it may cause the interference between the sound production portion 11 and the tragus of the user. If the length of the fifth connecting line CN is too small, it may cause the interference between the ear hook 13 and the front side of the auricle.

In some embodiments, in order to avoid the interference between the earphone 10 and the user's ear, when the sound production portion 11 is not in contact with the abutting portion 12 as shown in FIG. 4, the length of the fifth connecting line CN may be in a range of 13 mm-17 mm. In some embodiments, in order to further avoid the interference between the sound production portion 11 and the tragus, the length of the fifth connecting line CN may be in a range of 13.5 mm-16 mm. In some embodiments, to further avoid the interference between the sound production portion 11 and the front side of the auricle, the length of the fifth connecting line CN may be in a range of 14 mm-15.5 mm. Exemplarily, the length of the fifth connecting line CN may be 15 mm.

In some embodiments, when the sound production portion 11 comes in contact with the abutting portion 12 as shown in FIG. 6, the length of the fifth connecting line CN may be in a range of 12 mm-16 mm. Exemplarily, the length of the fifth connecting line CN may be 14.5 mm.

If an angle between the fifth connecting line CN and the first connecting line OC (i.e., ∠NCO) is too large, it may cause interference between the sound production portion 11 and the tragus. If the angle between the fifth connecting line CN and the first connecting line OC (i.e., ∠NCO) is too large, it may cause interference between the ear hook 13 and the front side of the auricle.

In some embodiments, in order to avoid the interference between the earphone 10 and the user's ear, when the sound production portion 11 is not in contact with the abutting portion 12 as shown in FIG. 4, the angle between the fifth connecting line CN and the first connecting line OC may be in a range of 13°-27°. In some embodiments, in order to further avoid the interference between the sound production portion 11 and the tragus, the angle between the fifth connecting line CN and the first connecting line OC may be in a range of 14°-25°. In some embodiments, to further avoid the interference between the sound production portion 11 and the front side of the auricle, the angle between the fifth connecting line CN and the first connecting line OC may be in a range of 18°-23°. Exemplarily, the angle between the fifth connecting line CN and the first connecting line OC may be 21°.

In some embodiments, when the sound production portion 11 comes in contact with the abutting portion 12 as shown in FIG. 6, the angle between the fifth connecting line CN and the first connecting line OC may in a range of be 12°-26°. Exemplarily, the angle between the fifth connecting line CN and the first connecting line OC may be 20°.

An extension line of the fifth connecting line CN is made to intersect the first projection 11′ at an eighth feature point M. In some embodiments, the eighth feature point M may be considered to be a point on the first projection 11′ that is farthest from the second feature point C. In some embodiments, a direction of a line connecting the second feature point C with the eighth feature point M is oriented generally in a direction of the ear canal opening of the user. In some embodiments, the sound outlet 111 opens toward the ear canal opening of the user, and the eighth feature point M may be located near the centroid J of the sound outlet 111, or the eighth feature point M may coincide with the centroid J of the sound outlet 111 (shown in FIG. 4).

A line connecting the seventh feature point N to the eighth feature point M is defined as a sixth connecting line (i.e., a connecting line NM). A curve segment of the first projection 11′ corresponding to the sixth connecting line NM (i.e., the arc NM) has a fourth arc length, and a ratio of the fourth arc length (i.e., the arc NM) to a length of the sixth connecting line (i.e., the connecting line NM) is defined as a fourth arc-string-ratio. The fourth arc-string-ratio may reflect the shape of the first projection 11′, thereby reflecting the shape of the sound production portion 11.

In some embodiments, when the sound production portion 11 is not in contact with the abutting portion 12 as shown in FIG. 4, or when the sound production portion 11 comes in contact with the abutting portion 12 as shown in FIG. 6, the fourth arc-string-ratio may be in a range of 1.4-1.7. This makes the arc NM approximately a semicircle, and the sixth connecting line NM may be regarded as a diameter of the first projection 11′. Thus, the sound production portion 11 is spherical or approximately spherical, so that the shape of the sound production portion 11 is adapted to fit the concha cavity, thereby enhancing the wearing comfort of the earphone 10. If a distance between the second feature point C and the eighth feature point M is too large, it may result in the sound production portion 11 blocking the ear canal opening of the user or interfering with the tragus. If the distance between the second feature point C and the eighth feature point M is too small, it may affect the size of the sound production portion 11 and thus the listening effect, or cause the sound production portion 11 to interfere with the antihelix.

In some embodiments, when the sound production portion 11 is not in contact with the abutting portion 12 as shown in FIG. 4, in order to avoid the sound production portion 11 blocking the ear canal opening of the user, and to prevent the sound production portion 11 from interfering with the tragus or the antihelix, and to ensure the user's listening effect, the distance between the second feature point C and the eighth feature point M may be in a range of 26.5 mm-29.5 mm. In some embodiments, to further prevent the sound production portion 11 from interfering with the tragus or blocking the ear canal opening, the distance between the second feature point C and the eighth feature point M may be in a range of 27 mm-29 mm. In some embodiments, to further prevent the sound production portion 11 from interfering with the antihelix, and to ensure the dimension of the sound production portion 11, the distance between the second feature point C and the eighth feature point M may be in a range of 27.5 mm-28 mm. Exemplarily, the distance between the second feature point C and the eighth feature point M may be 27.7 mm.

In some embodiments, when the sound production portion 11 comes in contact with the abutting portion 12 as shown in FIG. 6, the distance between the second feature point C and the eighth feature point M may be in a range of 27 mm-30 mm. Exemplarily, the distance between the second feature point C and the eighth feature point M may be 27.8 mm.

In some embodiments, a line passing through the second feature point C and biased towards the second projection 12′ is defined as a third auxiliary line L₆. The third auxiliary line L₆ and the contour of the second projection 12′ have at least one intersection point, an intersection point which is among the at least one intersection point and is farthest from the second feature point C is defined as a ninth feature point D. A line connecting the ninth feature point D with the second feature point C is defined as a sixth connecting line CD. In some embodiments, the point D is a point on the abutting portion 12 that is farthest from the second feature point C.

In some embodiments, the relative position of the ninth feature point D to the second feature point C may affect the position or attitude of the abutting portion 12 in the wearing state. If a distance between the ninth feature point D and the second feature point C (i.e., a length of the sixth connecting line CD) is too large, or if a third angle between the sixth connecting line CD and the first connecting line OC (i.e., ∠OCD) is too large, this may result in the abutting portion 12 interfering with the head skin on the rear side of the auricle of the user in the wearing state. If the distance between the ninth feature point D and the second feature point C (i.e., the length of the sixth connecting line CD) is too small, or if the third angle between the sixth connecting line CD and the first connecting line OC (i.e., ∠OCD) is too small, it may cause the abutting portion 12 to excessively squeeze the tissue on the rear side of the auricle of the user.

In some embodiments, when the sound production portion 11 is not in contact with the abutting portion 12 as shown in FIG. 4, in order to prevent the abutting portion 12 from excessively squeezing the ear and to avoid the interference between the abutting portion 12 and the head skin of the user, the length of the sixth connecting line CD may be less than 22 mm, and the third angle between the sixth connecting line CH and the first connecting line OC may be in a range of 18°-22°. In some embodiments, in order to further prevent the abutting portion 12 from excessively squeezing the ear, the length of the sixth connecting line CD may be greater than 17 mm, i.e., the length of the sixth connecting line CD may be in a range of 17 mm-22 mm, and the third angle between the sixth connecting line CH and the first connecting line OC may be in a range of 18.2°-19.8°. In some embodiments, to further avoid the interference between the abutting portion 12 and the head skin of the user, the length of the sixth connecting line CD may be in a range of 18.5 mm-20 mm, and the third angle between the sixth connecting line CH and the first connecting line OC may be in a range of 18.5°-19.2°. Exemplarily, the length of the fifth connecting line CD may be 19.8 mm, and the third angle between the fifth connecting line CH and the first connecting line OC may be 19°.

In some embodiments, when the sound production portion 11 comes in contact with the abutting portion 12 as shown in FIG. 6, the length of the sixth connecting line CD may be in a range of 16 mm-21 mm, and the third angle between the sixth connecting line CH and the first connecting line OC may be in a range of 18°-20°. Exemplarily, the length of the sixth connecting line CD may be 20.6 mm, and the third angle between the sixth connecting line CH and the first connecting line OC may be 21°.

It should be noted that data related to the earphone 10 in FIG. 2-FIG. 6 mentioned above are the data in the natural state when the earphone 10 is not worn, and FIG. 4 and FIG. 6 represent the natural state of the two different forms of the earphone 10, respectively.

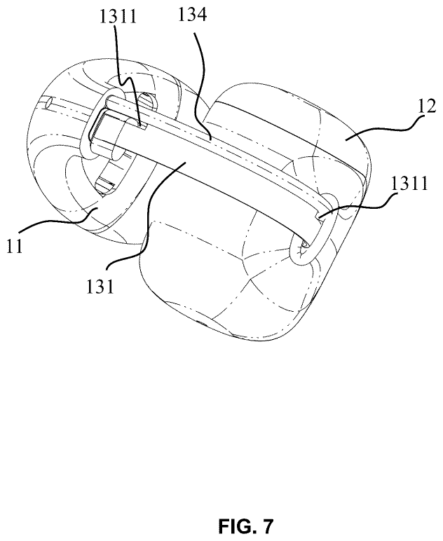

FIG. 7 is a schematic diagram illustrating an internal structure of an exemplary ear hook according to some embodiments of the present disclosure. Referring to FIG. 7, in some embodiments, the ear hook 13 comprises a metal sheet 131 and a flexible layer (not shown in the figure) wrapped around an outer side of the metal sheet 131. The metal sheet 131 is configured to connect the sound production portion 11 to the abutting portion 12, and the flexible layer is configured to protect the metal sheet 131. In some embodiments, the flexible layer further includes a wire 134 configured to provide an electrical signal connection between the sound production portion 11 and the abutting portion 12. In some embodiments, in order to reduce computational complexity and improve efficiency, the influence of the wire 134 may be disregarded when determining the first symmetry plane S1 of the ear hook 13.

In some embodiments, the metal sheet 131 has high support strength, good fatigue resistance, and a long service life. When the ear hook 13 is stretched, the metal sheet 131, which is the support structure of the ear hook 13, is not easily twisted. This facilitates the wearing of the sound production portion 11 and the abutting portion 12, and may reduce the possibility of the ear hook 13 being damaged by torsion, thereby enhancing the service life of the ear hook 13.

In some embodiments, the metal sheet 131 may include a resilient metal, such as titanium sheet, to allow for easy adjustment of the ear hook 13.

In some embodiments, the metal sheet 131 is located in the center of the ear hook 13, and the first symmetry plane S1 may coincide with a symmetry plane of the metal sheet 131 in the width direction. In some embodiments, if the width dimension of the metal sheet 131 is too large, it will lead to the size of the ear hook 13 being too large, and the ear hook 13 may interfere with the user's ear, thereby affecting the wearing effect of the earphone 10. If the width dimension of the metal sheet 131 is too small, it will lead to poor torsion resistance of the metal sheet 131, and during the stretching of the ear hook 13, the metal sheet 131 may be twisted, thereby affecting the form of the ear hook 13, and consequently affecting the wearing effect of the earphone 10.

In some embodiments, to avoid the interference between the ear hook 13 and the user's ear, and to ensure that the ear hook 13 maintains its form during stretching to achieve a good wearing effect of the earphone 10, the width dimension of the metal sheet 131 may be in a range of 1.5 mm-3 mm. In some embodiments, to further avoid the interference between the ear hook 13 and the user's ear, the width dimension of the metal sheet 131 may be in a range of 1.7 mm-2.7 mm. In some embodiments, to further prevent twisting of the metal sheet 131 during the stretching of the ear hook 13, thus enhancing service life of the metal sheet 131 and maintaining the shape of the ear hook 13, the width dimension of the metal sheet 131 may be in a range of 2 mm-2.5 mm.

In some embodiments, to provide the ear hook 13 with sufficient support strength, the thickness dimension of the metal sheet 131 may be in a range of 0.15 mm-0.3 mm. In some embodiments, to enable the metal sheet 131 to provide support for the ear hook 13, the thickness dimension of the metal sheet 131 may be in a range of 0.2 mm-0.25 mm.

The width dimension of the metal sheet 131 refers to a dimension of the metal sheet 131 in the direction perpendicular to the first symmetry plane S1. The thickness dimension of the metal sheet 131 refers to a dimension of the metal sheet 131 in a direction perpendicular to the length direction within the first symmetry plane S1.

In some embodiments, the metal sheet 131 may be provided with a flexible circuit board for easy routing and wiring. In some embodiments, the metal sheet 131 is provided with a recessed portion 1311 at each end that connects to the sound production portion 11 and the abutting portion 12, as shown in FIG. 7. The provision of the recessed portion 1311 facilitates the sealing of the ear hook 13 during mold forming.

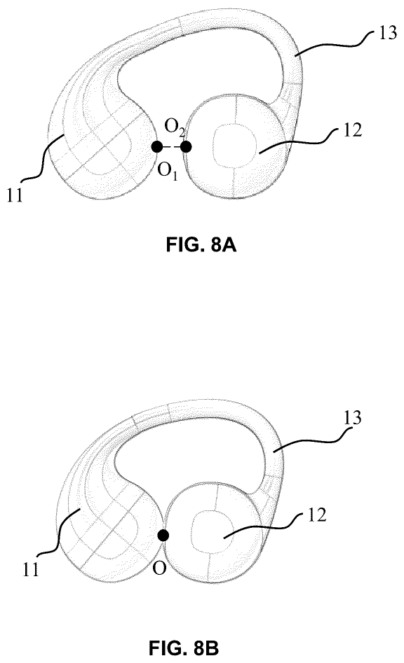

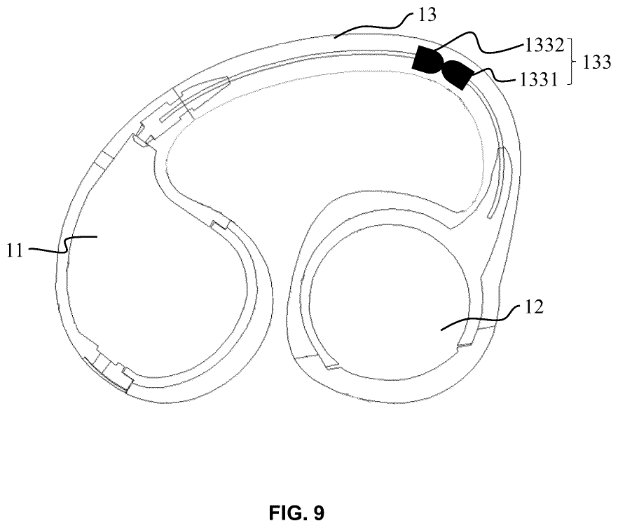

FIG. 8A is a schematic diagram illustrating an exemplary earphone in a first steady-state position according to some embodiments of the present disclosure. FIG. 8B is a schematic diagram illustrating an exemplary earphone in a second steady-state position according to some embodiments of the present disclosure. FIG. 9 is a schematic diagram illustrating an exemplary bistable structure according to some embodiments of the present disclosure. Referring to FIG. 8A, FIG. 8B, and FIG. 9, in some embodiments, a bistable structure 133 is provided on the metal sheet 131, and the bistable structure 133 is configured to provide the ear hook 13 with a first steady-state position (as shown in FIG. 8A) and a second steady-state position (as shown in FIG. 8B). By controlling the ear hook 13 to switch between the first steady-state position and the second steady-state position, the earphone 10 may be easily worn and removed. In some embodiments, the bistable structure 133 is provided near the second feature point, point C. Because of the difference in the degree of flatness of the inner contour curves of the third projection 13′ on either side of the second feature point C, by setting the bistable structure 133 near the second feature point C, it is possible to make a large difference between the first steady-state position and the second steady-state position, making it easy to wear or remove the earphone 10.

In some embodiments, the first steady-state position is set so as to facilitate the user's wearing of the earphone 10. The second steady-state position is set so as to enable the earphone 10 to be stably clamped on the user's ear. In some embodiments, the length of the shortest connecting line O₁O₂ corresponding to the first steady-state position is greater than the length of the shortest connecting line O₁O₂ corresponding to the second steady-state position, so as to facilitate the wearing of the earphone 10 to be clamped and removed. When the sound production portion 11 is in contact with the abutting portion 12, the length of the corresponding shortest connecting line O₁O₂ may be regarded as 0. In some embodiments, in order for the user's helix to be placed between the sound production portion 11 and the abutting portion 12 to bring the earphone 10 into the clamped position, the length of the shortest connecting line O₁O₂ corresponding to the first steady-state position may be greater than or equal to the thickness of the user's helix. In some embodiments, to enable the sound production portion 11 and the abutting portion 12 to clamp the user's helix for stable wearing of the earphone 10, the length of the shortest connecting line O₁O₂ corresponding to the second steady-state position may be less than the thickness of the user's helix. In some embodiments, when the ear hook 13 is in the first steady-state position, a distance (e.g., the length of the shortest connecting line O₁O₂) between the sound production portion 11 and the abutting portion 12 is farthest. When the ear hook 13 is in the second steady-state position, the distance (e.g., the length of the shortest connecting line O₁O₂) between the sound production portion 11 and the abutting portion 12 is closest. In some embodiments, the distance (e.g., the length of the shortest connecting line O₁O₂) between the sound production portion 11 and the abutting portion 12 when the earphone 10 is in the wearing state is greater than the distance between the sound production portion 11 and the abutting portion 12 when the ear hook 13 is in the second steady-state position.

In some embodiments, when the sound production portion 11 is not in contact with the abutting portion 12 as shown in FIG. 4, and when the ear hook 13 is in the first steady-state position, the earphone 10 may be in the position state shown in FIG. 4, and the length of the shortest connecting line O₁O₂ corresponding to the first steady-state position is greater than the length of the shortest connecting line O₁O₂ corresponding to the second steady-state position.

In some embodiments, when the sound production portion 11 comes in contact with the abutting portion 12 as shown in FIG. 6, and when the ear hook 13 is in the second steady-state position, the earphone 10 may be in the position state shown in FIG. 6. When the ear hook 13 is in the first steady-state position, the first projection 11′ is not in contact with the second projection 12′, i.e., the sound production portion 11 is not in contact with the abutting portion 12.

In some embodiments, when the user is ready to wear the earphone 10, if the ear hook 13 is in the first steady-state position, the user can hold and place the earphone 10 in a wearing position of the ear with one hand, and then exert a force (e.g., different fingers are pressed against the outer contour of the sound production portion 11 and the outer contour of the abutting portion 12 respectively, so as to make the sound production portion 11 and the abutting portion 12 come close to each other) to the earphone 10 with one hand, so as to cause the ear hook 13 to shift from the first steady-state position to the second steady-state position, thereby realizing the clamping wearing of the earphone 10.

In some embodiments, when the user is ready to wear the earphone 10, if the ear hook 13 is in the second steady-state position, the user may pull the abutting portion 12 away from the sound production portion 11 to shift the ear hook 13 from the second steady-state position to the first steady-state position for subsequent wearing.

In some embodiments, when the user is ready to remove the earphone 10 from the ear, the user may pull the abutting portion 12 away from the sound production portion 11 to shift the ear hook 13 from a position under the wearing state to the first steady-state position for removing the earphone 10.

Referring to FIG. 9, in some embodiments, the bistable structure 133 may comprise a convex portion 1331 and a contact portion 1332. The contact portion 1332 abuts against a convex point (not shown in the figure) of the convex portion 1331. When the contact portion 1332 abuts against the convex point of the convex portion 1331, the pressure between the contact portion 1332 and the convex portion 1331 is the maximum, and the contact portion 1332 is in an unstable state with the convex portion 1331. When the contact portion 1332 abuts against both sides of the convex point on the convex portion 1331, the pressure between the contact portion 1332 and the convex portion 1331 is reduced, and the contact portion 1332 is in a stable state with the convex portion 1331. That is, the contact portion 1332 abuts against one side of the convex point of the convex portion 1331 to form the first steady-state position, and the contact portion 1332 abuts against the other side of the convex point of the convex point of the convex portion 1331 to form the second steady-state position. In some embodiments, when the contact portion 1332 abuts against a side of the convex point on the convex portion 1331 that is away from the abutting portion 12 (i.e., a side proximate to the outer contour of the ear hook 13), the ear hook 13 is in the first steady-state position. When the contact portion 1332 abuts against a side of the convex point on the convex portion 1331 that is near to the abutting portion 12 (i.e., a side proximate to the inner contour of the ear hook 13), the ear hook 13 is in the second steady-state position.

In some embodiments, a design different from the bistable structure 133 may be employed to implement the switching of the earphone 10 between the first steady-state position and the second steady-state position. For example, the bistable structure may be implemented as a two-dimensional curved bistable structure, e.g., a bistable structure with different curvatures is formed by superimposing two layers of a sheet with a strain of 90° angle. As another example, the bistable structure 133 may be realized by designing smart materials (e.g., liquid crystals, hydrogels, shape memory polymers) as a beam structure. By changing the driving conditions of these smart materials (e.g., changing the magnetic field, electric field applied to the material), the switching of the earphone 10 between the two steady-state positions may be realized. Specifically, the earphone 10 may be provided with a key for switching the steady-state position, and an input of the key corresponds to the change of the driving condition described above.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of this disclosure.

Moreover, certain terminology has been used to describe embodiments of the present disclosure. As in “an embodiment”, “an embodiment”, and/or “some embodiments” means a feature, structure, or characteristic associated with at least one embodiment of the present application. Accordingly, it should be emphasized and noted that two or more references to “one embodiment” or “one embodiment” in different locations in this specification are not intended to refer to the same embodiment. In addition, some features, structures, or features in the present disclosure of one or more embodiments may be appropriately combined.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

Some embodiments use numbers to describe the number of components, attributes, and it should be understood that such numbers used in the description of the embodiments are modified in some examples by the modifiers “about”, “approximately”, or “substantially”. Unless otherwise noted, the terms “about,” “approximately,” or “approximately” indicates that a ±20% variation in the stated number is allowed. Correspondingly, in some embodiments, the numerical parameters used in the specification and claims are approximations, which can change depending on the desired characteristics of individual embodiments. In some embodiments, the numerical parameters should take into account the specified number of valid digits and employ general place-keeping. While the numerical domains and parameters used to confirm the breadth of their ranges in some embodiments of the present application are approximations, in specific embodiments such values are set to be as precise as possible within a feasible range.

For each patent, patent application, patent application disclosure, and other material cited in this application, such as articles, books, specifications, publications, documents, etc., the entire contents of which are hereby incorporated herein by reference. Except for application history documents that are inconsistent with or conflict with the contents of this application, and except for documents (currently or hereafter appended to this application) that limit the broadest scope of the claims of this application. It should be noted that in the event of any inconsistency or conflict between the descriptions, definitions, and/or use of terms in the materials appurtenant to this application and those set forth herein, the descriptions, definitions, and/or use of terms in this application shall prevail.

At last, it should be understood that the embodiments described in the present disclosure are merely illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. An ear-clip earphone, comprising:
a sound production portion configured to be positioned in a concha cavity of a user and contact an inner wall of the concha cavity, wherein the sound production portion comprises:
a housing having an accommodating cavity;
a sound production assembly accommodated within the accommodating cavity;
a sound outlet on the housing configured to transmit sound produced by the sound production assembly;
an abutting portion configured to abut behind the user's ear; and
an ear hook, wherein the ear hook is configured to bypass an antihelix and a helix of the user, and connect the sound production portion and the abutting portion, the ear hook has a first symmetry plane, the housing is projected onto the first symmetry plane to form a first projection, the abutting portion is projected onto the first symmetry plane to form a second projection, the ear hook is projected onto the first symmetry plane to form a third projection, the third projection includes an inner contour curve, wherein
a shortest connecting line is defined between the first projection and the second projection, and
a midpoint of the shortest connecting line is a first feature point,
a point on the inner contour curve that is farthest from the first feature point is a second feature point, and
a distance between the first feature point and the second feature point is in a range of 16 mm-20 mm.

2. The earphone of claim 1, wherein along a direction of the shortest connecting line, both the abutting portion and the second feature point are located on a same side of the first feature point.

3. (canceled)

4. The earphone of claim 2, wherein a line connecting the first feature point and the second feature point is defined as a first connecting line, and an angle between the first connecting line and the shortest connecting line is 50°-65°.

5. The earphone of claim 2, wherein a centroid of the second projection is defined as a third feature point, and in the direction of the shortest connecting line, the second feature point is further away from the first feature point than the third feature point.

6. The earphone of claim 5, wherein a line connecting the first feature point and the second feature point is defined as a first connecting line, and an angle between a line connecting the first feature point to the third feature point and the first connecting line is in a range of 42°-62°.

7. The earphone of claim 2, wherein
a line connecting the first feature point and the second feature point is defined as a first connecting line,
a line passing through the second feature point and biased towards the first projection is defined as a first auxiliary line,
a first angle between the first auxiliary line and the first connecting line has a first preset value range,
an intersection point between a curve segment, which is on the inner contour curve and connected to the first projection, and the first auxiliary line is defined as a fourth feature point,
a line connecting the fourth feature point and the second feature point is defined as a second connecting line, and
the first preset value range is 30°-40°.

8. (canceled)

9. The earphone of claim 7, wherein
a portion of the inner contour curve corresponding to the second connecting line has a first arc length,
a ratio of the first arc length to a length of the second connecting line is defined as a first arc-string-ratio, and
the first arc-string-ratio is in a range of 1.05-1.20.

10. The earphone of claim 7, wherein a portion of the inner contour curve corresponding to the second connecting line is defined as a first arc segment, and a distance from the second connecting line to the first arc segment is not greater than 3.4 mm.

11. The earphone of claim 7, wherein
with the fourth feature point as a center, a second arc segment and a third arc segment are determined on both sides of the fourth feature point,
an arc length of the second arc segment and an arc length of the third arc segment are both within a preset arc length range,
a line connecting an end of the second arc segment away from the fourth feature point and an end of the third arc segment away from the fourth feature point is defined as a third connecting line,
an arc segment corresponding to the third connecting line has a second arc length,
the preset arc length range is in a range of 2.5 mm-3.5 mm,
a ratio of the second arc length to a length of the third connecting line is defined as a second arc-string-ratio, and
the second arc-string-ratio is in a range of 1.26-1.44.

12. The earphone of claim 1, wherein
a line passing through the second feature point and biased towards the second projection is defined as a second auxiliary line,
a second angle between the second auxiliary line and the first connecting line has a second preset value range,
an intersection point between a curve segment, which is on the inner contour curve and connected to the second projection, and the second auxiliary line is defined as a fifth feature point,
a line connecting the fifth feature point and the second feature point is defined as a fourth connecting line, and
the second preset value range is 35°-50°.

13. (canceled)

14. The earphone of claim 12, wherein
a portion of the inner contour curve corresponding to the fourth connecting line has a third arc length,
a ratio of the third arc length to a length of the fourth connecting line is defined as a third arc-string-ratio, and
the third arc-string-ratio is in a range of 1.10-1.23.

15. The earphone of claim 1, wherein an intersection point between an extension line of the shortest connecting line and a contour of the first projection is a sixth feature point, and a distance between the first feature point and the sixth feature point is in a range of 12 mm-15 mm.

16. The earphone of claim 1, wherein
a line connecting the first feature point and the second feature point is defined as a first connecting line,
a point closest to the second feature point on the first projection is defined as a seventh feature point,
a line connecting the second feature point and the seventh feature point is defined as a fifth connecting line,
a length of the fifth connecting line is in a range of 13 mm-17 mm, and
an angle between the fifth connecting line and the first connecting line is in a range of 13°-27°.

17. The earphone of claim 16, wherein
an extension line of the fifth connecting line intersects with the first projection at an eighth feature point,
a line connecting the seventh feature point and the eighth feature point is defined as a sixth connecting line,
a curve segment of the first projection corresponding to the sixth connecting line has a fourth arc length,
a ratio of the fourth arc length to a length of the sixth connecting line is defined as a fourth arc-string-ratio, and
the fourth arc-string-ratio is in a range of 1.4-1.7.

18. (canceled)

19. The earphone of claim 1, wherein
a line connecting the first feature point and the second feature point is defined as a first connecting line,
a line passing through the second feature point and biased towards the second projection is defined as a third auxiliary line,
a third angle between the third auxiliary line and the first connecting line has a third preset value range,
the third auxiliary line and a contour of the second projection have at least one intersection point,
an intersection point which is among the at least one intersection point and is farthest from the second feature point is defined as a ninth feature point,
a line connecting the second feature point and the ninth feature point is defined as a sixth connecting line,
the third preset value range is 18°-22°, and
a length of the sixth connecting line is in a range of 17 mm-22 mm.

20. The earphone of claim 1, wherein in a wearing state, a point on the sound production portion, which corresponds to an endpoint of the shortest connecting line on the first projection, is covered by the concha cavity.

21. The earphone of claim 1, wherein
the ear hook comprises a metal sheet and a flexible layer wrapped around an outer side of the metal sheet,
two ends of the metal sheet in a length direction are respectively connected to the housing and the abutting portion,
a width dimension of the metal sheet is in a range of 1.5 mm-3 mm, and
a thickness of the metal sheet is in a range of 0.15 mm-0.3 mm.

22. The earphone of claim 21, wherein
a bistable structure is provided on the metal sheet, and the bistable structure is configured to provide the ear hook with a first steady-state position and a second steady-state position, wherein
a length of the shortest connecting line corresponding to the first steady-state position is greater than a length of the shortest connecting line corresponding to the second steady-state position.

23. The earphone of claim 22, wherein the bistable structure comprises a convex portion and a contact portion, wherein
the contact portion abuts against a convex point of the convex portion, and
the contact portion abuts against one side of the convex point to form the first steady-state position, and the contact portion abuts against the other side of the convex point to form the second steady-state position.

24. An ear-clip earphone, comprising:
a sound production portion configured to be positioned in a concha cavity of a user and contact an inner wall of the concha cavity, wherein the sound production portion comprises:
a housing having an accommodating cavity;
a sound production assembly accommodated within the accommodating cavity;
a sound outlet on the housing configured to transmit sound produced by the sound production assembly;
an abutting portion configured to abut behind the user's ear; and
an ear hook, wherein the ear hook is configured to bypass an antihelix and a helix of the user, and connect the sound production portion and the abutting portion, the ear hook has a first symmetry plane, the housing is projected onto the first symmetry plane to form a first projection, the abutting portion is projected onto the first symmetry plane to form a second projection, the ear hook is projected onto the first symmetry plane to form a third projection, the third projection includes an inner contour curve, wherein
the first projection and the second projection are in contact,
between the first projection and the second projection, the first projection and the second projection have a first common tangent line,
the first common tangent line is tangent to both the first projection and the second projection at a first tangent point, which is a first feature point,
a point on the inner contour curve that is farthest from the first feature point is a second feature point, and
a distance between the first feature point and the second feature point is in a range of 16.5 mm-20.5 mm.

25-46. (canceled)
